(19) United States
(12) Patent Application Publication
(10) Pub. No.: US 2015/0205664 A1
(43) Pub. Date: Jul. 23, 2015

(54) DETERMINING A CONFIGURATION PARAMETER USING A SOFT READ COMMAND

(71) Applicant: Fusion-io, Inc., Salt Lake City, UT (US)

(72) Inventors: Gary Janik, San Jose, CA (US); Yangyang Pan, San Jose, CA (US)

(73) Assignee: Fusion-io, Inc., Salt Lake City, UT (US)

(21) Appl. No.: 14/198,371

(22) Filed: Mar. 5, 2014

Related U.S. Application Data
(60) Provisional application No. 61/928,858, filed on Jan. 17, 2014.

(51) Int. Cl. G06F 11/10

(52) U.S. Cl. CPC G06F 11/1008

(57) ABSTRACT

Apparatuses, methods, and computer program products are disclosed for determining read thresholds for a non-volatile memory device. A method includes obtaining soft read data for a storage cell of a non-volatile storage medium. A method includes determining a read voltage threshold or other configuration parameter for a storage cell based on soft read data. A method includes using a determined read voltage threshold or other configuration parameter to read data from a storage cell.

### CROSS-REFERENCES TO RELATED APPLICATIONS

This application claims the benefit of United States Provisional Patent Application Number 61/928,858 entitled “DETERMINING A CONFIGURATION PARAMETER USING A SOFT READ COMMAND” and filed on Jan. 17, 2014 for Gary Janik, et al., which is incorporated herein by reference.

### TECHNICAL FIELD

The present disclosure, in various embodiments, relates to configuration parameters such as read voltage thresholds and more particularly relates to using soft read information to determine a hard read threshold or another configuration parameter for a storage cell of a non-volatile memory device.

### BACKGROUND

Many non-volatile storage devices distinguish between different binary values that a storage cell may store based on a physical property of the cell, such as a read voltage level or another configuration parameter of the storage cell. A cell's physical property may be variable across a range, which may be divided into discrete states, so that different states correspond to different data values. Sensing whether the cell's physical property satisfies one or more read thresholds (e.g., voltage thresholds, resistivity thresholds, or the like) determines the cell's state, allowing recovery of a stored data value.

Stored data values, read voltage levels, resistivity, or the like, however, can shift over time. For example, storage cell damage, storage cell leakage, temperature, and other disturbances to storage cells can alter the state of a storage cell, making different configuration parameters more optimal for the storage cell. The rate of leakage and other disturbances can also increase with age as storage cells are used over time. If the read voltage level or other configuration parameter of a storage cell shifts past a threshold for the storage cell, a data error occurs, as the value of the data read from the storage cell is different than the value of the data written to the storage cell.

### SUMMARY

Methods are presented for determining configuration parameters for a non-volatile memory device. In one embodiment, a method includes obtaining soft read data for a storage cell of a non-volatile storage medium. A method, in a further embodiment, includes determining a configuration parameter for a storage cell based on soft read data. In certain embodiments, a method includes using a determined configuration parameter to read data from a storage cell.

Apparatuses are presented for determining configuration parameters for a non-volatile memory device. In one embodiment, a soft read module is configured to issue a soft read command for a set of cells of a non-volatile memory medium. In one embodiment, a parameter module is configured to adjust a read voltage threshold for a set of cells based on soft read information received in response to a soft read command. An error-correcting code (ECC) decoder, in a further embodiment, is configured to correct one or more errors in data of a set of storage cells using soft read information.

An apparatus, in another embodiment, includes means for obtaining soft sensing information for storage cells of a non-volatile recording medium in response to a read request. In one embodiment, an apparatus includes means for determining a read voltage threshold for storage cells. The read voltage threshold for the storage cells, in certain embodiments, are determined based on the soft sensing information. In a further embodiment, an apparatus includes means for reading data from storage cells using the determined read voltage threshold.

Computer program products are presented comprising a computer readable storage medium storing computer usable program code executable to perform operations for determining configuration parameters for a non-volatile memory device. In one embodiment, an operation includes sending a soft read command for a cell of a non-volatile storage medium. An operation, in a further embodiment, includes determining a stored read voltage level for a cell based on soft read information received in response to the soft read command. In certain embodiments, an operation includes updating a read voltage threshold parameter for a cell based on a stored read voltage level.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for determining configuration parameters for a non-volatile memory device;

FIG. 2 is a schematic block diagram illustrating one embodiment of an apparatus for determining configuration parameters for a non-volatile memory device;

FIG. 3 is a schematic block diagram illustrating another embodiment of an apparatus for determining configuration parameters for a non-volatile memory device;

FIG. 4A is a graph illustrating one embodiment of a distribution for cells of a non-volatile memory medium;

FIG. 4B is a graph illustrating another embodiment of a distribution for cells of a non-volatile memory medium;

FIG. 5 is a schematic flow chart diagram illustrating one embodiment of a method for determining configuration parameters for a non-volatile memory device;

FIG. 6 is a schematic flow chart diagram illustrating another embodiment of a method for determining configuration parameters for a non-volatile memory device; and

FIG. 7 is a schematic flow chart diagram illustrating a further embodiment of a method for determining configuration parameters for a non-volatile memory device.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), phase change memory (PRAM or PCM), a portable compact disc read-only memory (CD-ROM), a digital versatile disc (DVD), a blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, or the like, to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

According to various embodiments, a non-volatile memory controller manages one or more non-volatile memory devices. The non-volatile memory device(s) may comprise memory or storage devices, such as solid-state storage device(s), that are arranged and/or partitioned into a plurality of addressable media storage locations. As used herein, a media storage location refers to any physical unit of memory (e.g., any quantity of physical storage media on a non-volatile memory device). Memory units may include, but are not limited to: pages, memory divisions, erase blocks, sectors, blocks, collections or sets of physical storage locations (e.g., logical pages, logical erase blocks, described below), or the like.

The non-volatile memory controller may comprise a storage management layer (SML), which may present a logical address space to one or more storage clients. One example of an SML is the Virtual Storage Layer® of Fusion-io, Inc. of Salt Lake City, Utah. Alternatively, each non-volatile memory device may comprise a non-volatile memory media controller, which may present a logical address space to the storage clients. As used herein, a logical address space refers to a logical representation of memory resources. The logical address space may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

The SML may maintain metadata, such as a forward index, to map logical addresses of the logical address space to media storage locations on the non-volatile memory device(s). The SML may provide for arbitrary, any-to-any mappings from logical addresses to physical storage resources. As used herein, an “any-to any” mapping may map any logical address to any physical storage resource. Accordingly, there may be no pre-defined and/or pre-set mappings between logical addresses and particular, media storage locations and/or media addresses. As used herein, a media address refers to an address of a memory resource that uniquely identifies one memory resource from another to a controller that manages a plurality of memory resources. By way of example, a media address includes, but is not limited to: the address of a media storage location, a physical memory unit, a collection of physical memory units (e.g., a logical memory unit), a portion of a memory unit (e.g., a logical memory unit address and offset, range, and/or extent), or the like. Accordingly, the SML may map logical addresses to physical data resources of any size and/or granularity, which may or may not correspond to the underlying data partitioning scheme of the non-volatile memory device(s). For example, in some embodiments, the non-volatile memory controller is configured to store data within logical memory units that are formed by logically combining a plurality of physical memory units, which may allow the non-volatile memory controller to support many different virtual memory unit sizes and/or granularities.

As used herein, a logical memory element refers to a set of two or more non-volatile memory elements that are or are capable of being managed in parallel (e.g., via an I/O and/or control bus). A logical memory element may comprise a plurality of logical memory units, such as logical pages, logical memory divisions (e.g., logical erase blocks), and so on. As used herein, a logical memory unit refers to a logical construct combining two or more physical memory units, each physical memory unit on a respective non-volatile memory element in the respective logical memory element (each non-volatile memory element being accessible in parallel). As used herein, a logical memory division refers to a set of two or more physical memory divisions, each physical memory division on a respective non-volatile memory element in the respective logical memory element.

The logical address space presented by the storage management layer may have a logical capacity, which may correspond to the number of available logical addresses in the logical address space and the size (or granularity) of the data referenced by the logical addresses. For example, the logical capacity of a logical address space comprising 2̂32 unique logical addresses, each referencing 2048 bytes (2 KiB) of data may be 2̂43 bytes. (As used herein, a kibibyte (KiB) refers to 1024 bytes). In some embodiments, the logical address space may be thinly provisioned. As used herein, a “thinly provisioned” logical address space refers to a logical address space having a logical capacity that exceeds the physical capacity of the underlying non-volatile memory device(s). For example, the storage management layer may present a 64-bit logical address space to the storage clients (e.g., a logical address space referenced by 64-bit logical addresses), which exceeds the physical capacity of the underlying non-volatile memory devices. The large logical address space may allow storage clients to allocate and/or reference contiguous ranges of logical addresses, while reducing the chance of naming conflicts. The storage management layer may leverage the any-to-any mappings between logical addresses and physical storage resources to manage the logical address space independently of the underlying physical storage devices. For example, the storage management layer may add and/or remove physical storage resources seamlessly, as needed, and without changing the logical addresses used by the storage clients.

The non-volatile memory controller may be configured to store data in a contextual format. As used herein, a contextual format refers to a self-describing data format in which persistent contextual metadata is stored with the data on the physical storage media. The persistent contextual metadata provides context for the data it is stored with. In certain embodiments, the persistent contextual metadata uniquely identifies the data that the persistent contextual metadata is stored with. For example, the persistent contextual metadata may uniquely identify a sector of data owned by a storage client from other sectors of data owned by the storage client. In a further embodiment, the persistent contextual metadata identifies an operation that is performed on the data. In a further embodiment, the persistent contextual metadata identifies a sequence of operations performed on the data. In a further embodiment, the persistent contextual metadata identifies security controls, a data type, or other attributes of the data. In a certain embodiment, the persistent contextual metadata identifies at least one of a plurality of aspects, including data type, a unique data identifier, an operation, and a sequence of operations performed on the data. The persistent contextual metadata may include, but is not limited to: a logical address of the data, an identifier of the data (e.g., a file name, object id, label, unique identifier, or the like), reference(s) to other data (e.g., an indicator that the data is associated with other data), a relative position or offset of the data with respect to other data (e.g., file offset), data size and/or range, and the like. The contextual data format may comprise a packet format comprising a data segment and one or more headers. Alternatively, a contextual data format may associate data with context information in other ways (e.g., in a dedicated index on the non-volatile memory media, a memory division index, or the like).

In some embodiments, the contextual data format may allow data context to be determined (and/or reconstructed) based upon the contents of the non-volatile memory media, and independently of other metadata, such as the arbitrary, any-to-any mappings discussed above. Since the media location of data is independent of the logical address of the data, it may be inefficient (or impossible) to determine the context of data based solely upon the media location or media address of the data. Storing data in a contextual format on the non-volatile memory media may allow data context to be determined without reference to other metadata. For example, the contextual data format may allow the metadata to be reconstructed based only upon the contents of the non-volatile memory media (e.g., reconstruct the any-to-any mappings between logical addresses and media locations).

In some embodiments, the non-volatile memory controller may be configured to store data on one or more asymmetric, write-once media, such as solid-state storage media. As used herein, a “write once” storage medium refers to a storage medium that is reinitialized (e.g., erased) each time new data is written or programmed thereon. As used herein, an “asymmetric” storage medium refers to a storage medium having different latencies for different storage operations. Many types of solid-state storage media are asymmetric; for example, a read operation may be much faster than a write/program operation, and a write/program operation may be much faster than an erase operation (e.g., reading the media may be hundreds of times faster than erasing, and tens of times faster than programming the media). The memory media may be partitioned into memory divisions that can be erased as a group (e.g., erase blocks) in order to, inter alia, account for the asymmetric properties of the media. As such, modifying a single data segment in-place may require erasing the entire erase block comprising the data, and rewriting the modified data to the erase block, along with the original, unchanged data. This may result in inefficient “write amplification,” which may excessively wear the media. Therefore, in some embodiments, the non-volatile memory controller may be configured to write data out-of-place. As used herein, writing data “out-of-place” refers to writing data to different media storage location(s) rather than overwriting the data “in-place” (e.g., overwriting the original physical location of the data). Modifying data out-of-place may avoid write amplification, since existing, valid data on the erase block with the data to be modified need not be erased and recopied. Moreover, writing data out-of-place may remove erasure from the latency path of many storage operations (the erasure latency is no longer part of the critical path of a write operation).

The non-volatile memory controller may comprise one or more processes that operate outside of the regular path for servicing of storage operations (the “path” for performing a storage operation and/or servicing a storage request). As used herein, the “path for servicing a storage request” or “path for servicing a storage operation” (also referred to as the “critical path”) refers to a series of processing operations needed to service the storage operation or request, such as a read, write, modify, or the like. The path for servicing a storage request may comprise receiving the request from a storage client, identifying the logical addresses of the request, performing one or more storage operations on non-volatile memory media, and returning a result, such as acknowledgement or data. Processes that occur outside of the path for servicing storage requests may include, but are not limited to: a groomer, de-duplication, and so on. These processes may be implemented autonomously and in the background, so that they do not interfere with or impact the performance of other storage operations and/or requests. Accordingly, these processes may operate independent of servicing storage requests.

In some embodiments, the non-volatile memory controller comprises a groomer, which is configured to reclaim memory divisions (e.g., erase blocks) for reuse. The write out-of-place paradigm implemented by the non-volatile memory controller may result in obsolete or invalid data remaining on the non-volatile memory media. For example, overwriting data X with data Y may result in storing Y on a new memory division (rather than overwriting X in place), and updating the any-to-any mappings of the metadata to identify Y as the valid, up-to-date version of the data. The obsolete version of the data X may be marked as invalid, but may not be immediately removed (e.g., erased), since, as discussed above, erasing X may involve erasing an entire memory division, which is a time-consuming operation and may result in write amplification. Similarly, data that is no longer is use (e.g., deleted or trimmed data) may not be immediately removed. The non-volatile memory media may accumulate a significant amount of invalid data. A groomer process may operate outside of the critical path for servicing storage operations. The groomer process may reclaim memory divisions so that they can be reused for other storage operations. As used herein, reclaiming a memory division refers to erasing the memory division so that new data may be stored/programmed thereon. Reclaiming a memory division may comprise relocating valid data on the memory division to a new location. The groomer may identify memory divisions for reclamation based upon one or more factors, which may include, but are not limited to: the amount of invalid data in the memory division, the amount of valid data in the memory division, wear on the memory division (e.g., number of erase cycles), time since the memory division was programmed or refreshed, and so on.

The non-volatile memory controller may be further configured to store data in a log format. As described above, a log format refers to a data format that defines an ordered sequence of storage operations performed on a non-volatile memory media. In some embodiments, the log format comprises storing data in a pre-determined sequence of media addresses of the non-volatile memory media (e.g., within sequential pages and/or erase blocks of the media). The log format may further comprise associating data (e.g., each packet or data segment) with respective sequence indicators. The sequence indicators may be applied to data individually (e.g., applied to each data packet) and/or to data groupings (e.g., packets stored sequentially on a memory division, such as an erase block). In some embodiments, sequence indicators may be applied to memory divisions when the memory divisions are reclaimed (e.g., erased), as described above, and/or when the memory divisions are first used to store data.

In some embodiments the log format may comprise storing data in an “append only” paradigm. The non-volatile memory controller may maintain a current append point at a media address of the non-volatile memory device. The append point may be a current memory division and/or offset within a memory division. Data may then be sequentially appended from the append point. The sequential ordering of the data, therefore, may be determined based upon the sequence indicator of the memory division of the data in combination with the sequence of the data within the memory division. Upon reaching the end of a memory division, the non-volatile memory controller may identify the “next” available memory division (the next memory division that is initialized and ready to store data). The groomer may reclaim memory divisions comprising invalid, stale, and/or deleted data, to ensure that data may continue to be appended to the media log.

The log format described herein may allow valid data to be distinguished from invalid data based upon the contents of the non-volatile memory media, and independently of other metadata. As discussed above, invalid data may not be removed from the non-volatile memory media until the memory division comprising the data is reclaimed. Therefore, multiple “versions” of data having the same context may exist on the non-volatile memory media (e.g., multiple versions of data having the same logical addresses). The sequence indicators associated with the data may be used to distinguish invalid versions of data from the current, up-to-date version of the data; the data that is the most recent in the log is the current version, and previous versions may be identified as invalid.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description.

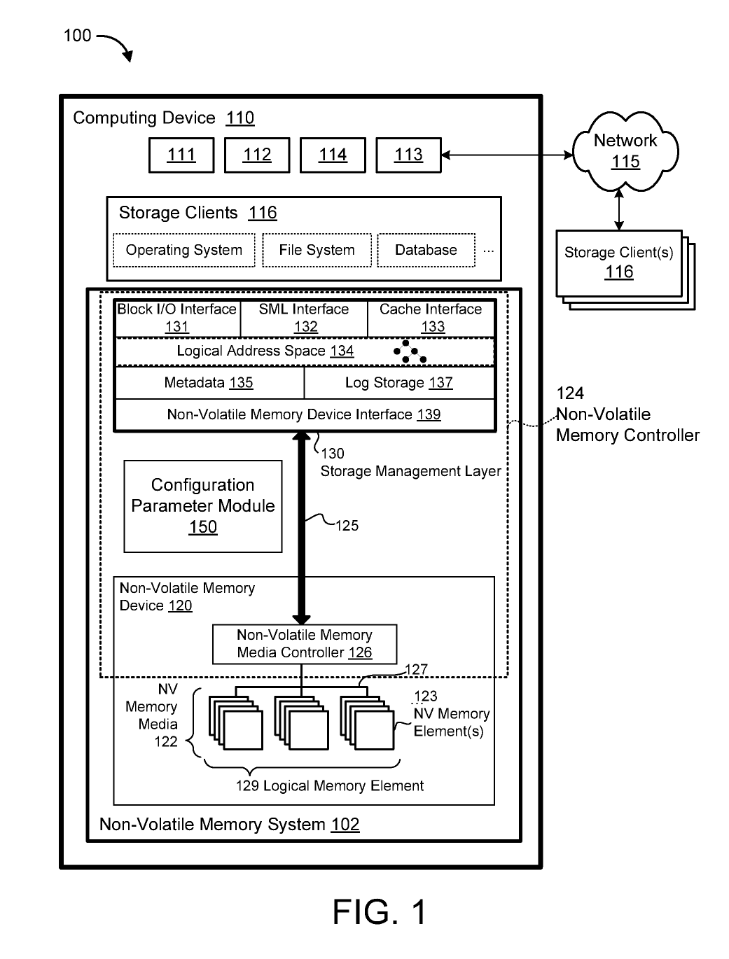

FIG. 1 is a block diagram of one embodiment of a system 100 comprising a configuration parameter module 150. The configuration parameter module 150 may be part of and/or in communication with a storage management layer (SML) 130, part of and/or in communication with a non-volatile memory media controller 126, or the like. The SML 130 may operate on a non-volatile memory system 102 of a computing device 110, which may comprise a processor 111, volatile memory 112, and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 (and/or non-volatile memory controller 124) to a communication network, such as an Internet Protocol network, a Storage Area Network, or the like.

The computing device 110 may further comprise a non-transitory, computer readable storage media 114. The computer readable storage media 114 may comprise executable instructions configured to cause the computing device 110 (e.g., processor 111) to perform steps of one or more of the methods disclosed herein. Alternatively, or in addition, the storage management layer 130 and/or one or more modules thereof may be embodied as one or more computer readable instructions stored on the non-transitory storage media 114.

The storage management layer 130 may be configured to provide storage services to one or more storage clients 116. The storage clients 116 may include local storage clients 116 operating on the computing device 110 and/or remote, storage clients 116 accessible via the network (and network interface 113). The storage clients 116 may include, but are not limited to: operating systems, file systems, database applications, server applications, kernel-level processes, user-level processes, applications, and the like.

The storage management layer 130 comprises and/or is communicatively coupled to one or more non-volatile memory devices 120. The one or more non-volatile memory devices 120 may include different types of non-volatile memory devices including, but not limited to: solid-state storage devices, hard drives, SAN storage resources, or the like. The one or more non-volatile memory devices 120 may comprise one or more respective non-volatile memory media controllers 126 and non-volatile memory media 122. As illustrated in FIG. 1, The SML 130 may provide access to the one or more non-volatile memory devices 120 via a traditional block I/O interface 131. Additionally, the SML 130 may provide access to enhanced functionality (large, virtual address space) through the SML interface 132. The metadata 135 may be used to manage and/or track storage operations performed through any of the Block I/O interface 131, SML interface 132, cache interface 133, or other, related interfaces.

The cache interface 133 may expose cache-specific features accessible via the storage management layer 130. Also, in some embodiments, the SML interface 132 presented to the storage clients 116 provides access to data transformations implemented by the one or more non-volatile memory devices 120 and/or the one or more non-volatile memory media controllers 126.

The SML 130 may provide storage services through one or more interfaces, which may include, but are not limited to: a block I/O interface, an extended storage management layer interface, a cache interface, and the like. The SML 130 may present a logical address space 134 to the storage clients 116 through one or more interfaces. As discussed above, the logical address space 134 may comprise a plurality of logical addresses, each corresponding to respective media locations on the one or more non-volatile memory devices 120. The SML 130 may maintain metadata 135 comprising any-to-any mappings between logical addresses and media locations, as described above.

The SML 130 may further comprise a log storage module 137 that is configured to store data in a contextual, log format. The contextual, log data format may comprise associating data with persistent contextual metadata, such as the logical address of the data, or the like. The contextual, log format may further comprise associating data with respective sequence identifiers on the one or more non-volatile memory media 122, which define an ordered sequence of storage operations performed on the one or more non-volatile memory devices 120, as described above.

The SML 130 may further comprise a non-volatile memory device interface 139 configured to transfer data, commands, and/or queries to the one or more non-volatile memory devices 120 over a bus 125, which may include, but is not limited to: a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network, Infiniband, SCSI RDMA, or the like. The non-volatile memory device interface 139 may communicate with the one or more non-volatile memory devices 120 using input-output control (IO-CTL) command(s), IO-CTL command extension(s), remote direct memory access, or the like.

The non-volatile memory system 102, in the depicted embodiment, includes a configuration parameter module 150. The configuration parameter module 150, in various embodiments, is configured to determine soft read data or information for one or more storage cells of the non-volatile memory media 122, to determine a read threshold for the storage cell(s) based on the soft read data or information, to configure the non-volatile memory media 122 to use the determined read threshold when accessing data stored in the storage cell(s), or the like. Advantageously, in certain embodiments, the configuration parameter module 150 may use one or more soft read commands provided by the non-volatile memory device 120, the non-volatile memory media controller 126, the non-volatile memory media 122, or the like to determine how a stored read voltage level for a storage cell has drifted or changed over time, allowing the configuration parameter module 150 to determine and set one or more read voltage thresholds or other configuration parameters for the storage cell thereby preventing or correcting a data error for the cell. The configuration parameter module 150, in one embodiment, may dynamically and/or proactively determine and set one or more read voltage thresholds or other configuration parameters for storage cells of the non-volatile memory media 122 to reduce errors, prevent errors from occurring, or the like. By proactively and/or dynamically adjusting read voltage thresholds or other configuration parameters, the configuration parameter module 150 may increase a retention rate for and/or the reliability of data stored in the non-volatile memory media 122 and extend the useable lifetime of the non-volatile memory media 122 itself.

In one embodiment, the configuration parameter module 150 may comprise executable software code, such as a device driver, SML 130, or the like, stored on the computer readable storage media 114 for execution on the processor 111. In another embodiment the configuration parameter module 150 may comprise logic hardware of the one or more non-volatile memory devices 120, such as a non-volatile memory media controller 126, a non-volatile memory controller 124, a device controller, a field-programmable gate array (FPGA) or other programmable logic, firmware for an FPGA or other programmable logic, microcode for execution on a microcontroller, an application-specific integrated circuit (ASIC), or the like. In a further embodiment, the configuration parameter module 150 may include a combination of both executable software code and logic hardware.

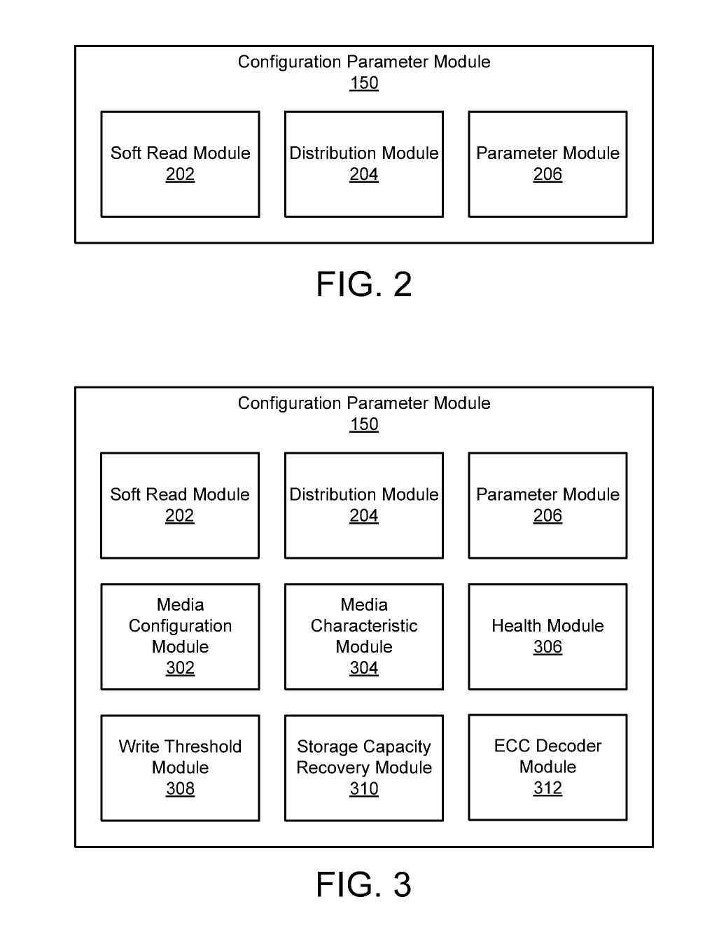

In one embodiment, the configuration parameter module 150 is configured to receive storage requests from the SML 130 via a bus 125 or the like. The configuration parameter module 150 may be further configured to transfer data to/from the SML 130 and/or storage clients 116 via the bus 125. Accordingly, the configuration parameter module 150, in some embodiments, may comprise and/or be in communication with one or more direct memory access (DMA) modules, remote DMA modules, bus controllers, bridges, buffers, and so on to facilitate the transfer of storage requests and associated data. In another embodiment, the configuration parameter module 150 may receive storage requests as an API call from a storage client 116, as an IO-CTL command, or the like. The configuration parameter module 150 is described in greater detail below with regard to FIGS. 2 and 3.

As described above, the configuration parameter module 150 may be part of and/or in communication with a storage management layer 130. The SML 130 may operate on a non-volatile memory system 102 of a computing device 110, which, as discussed above, may comprise a processor 111, volatile memory 112, communication interface 113, and non-transitory, computer readable storage media 114. The communication interface 113 may comprise one or more network interfaces configured to communicatively couple the computing device 110 (and/or non-volatile memory controller 124) to a network 115 and/or to one or more remote, network-accessible storage clients 116.

The computing device 110 may comprise a non-volatile memory controller 124 that is configured to provide storage services to the storage clients 116. The storage clients 116 may include local storage clients 116 operating on the computing device 110 and/or remote, storage clients 116 accessible via the network 115 (and network interface 113). The non-volatile memory controller 124 comprises one or more non-volatile memory devices 120. Although FIG. 1 depicts a single non-volatile memory device 120, the disclosure is not limited in this regard and could be adapted to incorporate any number of non-volatile memory devices 120.

The non-volatile memory device 120 may comprise non-volatile memory media 122, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change memory (PRAM or PCM), magnetic storage media (e.g., hard disk, tape), optical storage media, or the like. While the non-volatile memory media 122 is referred to herein as “memory media,” in various embodiments, the non-volatile memory media 122 may more generally comprise a non-volatile recording media capable of recording data, which may be referred to as a non-volatile memory media, a non-volatile storage media, or the like. Further, the non-volatile memory device 120, in various embodiments, may comprise a non-volatile recording device, a non-volatile memory device, a non-volatile storage device, or the like.

The non-volatile memory media 122 may comprise one or more non-volatile memory elements 123, which may include, but are not limited to: chips, packages, planes, die, and the like. A non-volatile memory media controller 126 may be configured to manage storage operations on the non-volatile memory media 122, and may comprise one or more processors, programmable processors (e.g., field-programmable gate arrays), or the like. In some embodiments, the non-volatile memory media controller 126 is configured to store data on (and read data from) the non-volatile memory media 122 in the contextual, log format described above, and to transfer data to/from the non-volatile memory device 120, and so on.

The non-volatile memory media controller 126 may be communicatively coupled to the non-volatile memory media 122 by way of a bus 127. The bus 127 may comprise an I/O bus for communicating data to/from the non-volatile memory elements 123. The bus 127 may further comprise a control bus for communicating addressing and other command and control information to the non-volatile memory elements 123. In some embodiments, the bus 127 may communicatively couple the non-volatile memory elements 123 to the non-volatile memory media controller 126 in parallel. This parallel access may allow the non-volatile memory elements 123 to be managed as a group, forming a logical memory element 129. As discussed above, the logical memory element may be partitioned into respective logical memory units (e.g., logical pages) and/or logical memory divisions (e.g., logical erase blocks). The logical memory units may be formed by logically combining physical memory units of each of the non-volatile memory elements. For example, if the non-volatile memory media 122 comprises twenty-five (25) non-volatile memory elements, each logical memory unit may comprise twenty-five (25) pages (a page of each element of non-volatile memory media 122).

The non-volatile memory controller 124 may comprise a SML 130 and the non-volatile memory media controller 126. The SML 130 may provide storage services to the storage clients 116 via one or more interfaces 131, 132, and/or 133. In some embodiments, the SML 130 provides a block-device I/O interface 131 through which storage clients 116 perform block-level I/O operations. Alternatively, or in addition, the SML 130 may provide a storage management layer (SML) interface 132, which may provide other storage services to the storage clients 116. In some embodiments, the SML interface 132 may comprise extensions to the block device interface 131 (e.g., storage clients 116 may access the SML interface 132 through extensions to the block device interface 131). Alternatively, or in addition, the SML interface 132 may be provided as a separate API, service, and/or library. The SML 130 may be further configured to provide a cache interface 133 for caching data using the non-volatile memory system 102.

As described above, the SML 130 may present a logical address space 134 to the storage clients 116 (through the interfaces 131, 132, and/or 133). The SML 130 may maintain metadata 135 comprising any-to-any mappings between logical addresses in the logical address space 134 and media locations on the non-volatile memory device 120. The metadata 135 may comprise a logical-to-physical mapping structure with entries that map logical addresses in the logical address space 134 and media locations on the non-volatile memory device 120. The logical-to-physical mapping structure of the metadata 135, in one embodiment, is sparsely populated, with entries for logical addresses for which the non-volatile memory device 120 stores data and with no entries for logical addresses for which the non-volatile memory device 120 does not currently store data. The metadata 135, in certain embodiments, tracks data at a block level, with the SML 130 managing data as blocks.

The non-volatile memory system 102 may further comprise a log storage module 137, which, as described above, may be configured to store data on the non-volatile memory device 120 in a contextual, log format. The contextual, log data format may comprise associating data with a logical address on the non-volatile memory media 122. The contextual, log format may further comprise associating data with respective sequence identifiers on the non-volatile memory media 122, which define an ordered sequence of storage operations performed on the non-volatile memory media 122, as described above. The non-volatile memory controller 124 may further comprise a non-volatile memory device interface 139 that is configured to transfer data, commands, and/or queries to the non-volatile memory media controller 126 over a bus 125, as described above.

As used herein, a configuration parameter for a set of storage cells or other non-volatile memory media 122 is a parameter that is modifiable by way of an interface. The interface may comprise a publicly known interface or a proprietary interface and may include use of particular command instructions and/or use of particular parameters, register settings, driver settings, controller settings, a particular set of command instruction sequences, or other differences from regular commands (general purpose commands) or settings used to interface with, or manage, the set of storage cells. Configuration parameters may relate to writing to, or programming, storage cells, reading from storage cells, erasing storage cells, managing storage cells, device driver or storage controller settings for storage cells, or the like. A configuration parameter for a set of storage cells may be associated with a device driver for the non-volatile memory device 120, with a non-volatile memory controller 124, or the like, and may relate to how the device driver and/or non-volatile memory controller 124 use, manage, and interact with the set of storage cells and/or the non-volatile memory media 122.

One embodiment of a configuration parameter for reading from storage cells is a read threshold, such as a read voltage threshold, a resistivity threshold, or the like. A read voltage threshold is a voltage level that separates discrete values stored in the storage cells of the non-volatile memory media 122. A storage cell may comprise a plurality of read voltage thresholds. One or more read voltage thresholds may be used to define a range of discrete values that are interpreted to represent a particular data value for a storage cell. Different non-volatile memory technologies may use different thresholds other than voltages to distinguish between discrete states. Phase change RAM or PRAM, for example, stores data in chalcogenide glass that has different electrical resistivity in different states. For PRAM, the read thresholds are resistivity thresholds that distinguish between discrete storage states. One of skill in the art, in light of this disclosure, will recognize that the configuration parameter module 150 may determine, set, and adjust resistivity thresholds or other configuration parameters in a substantially similar manner to that described herein with regard to read voltage thresholds.

Various embodiments of configuration parameters for writing/programming storage cells include a step magnitude for an incremental step pulse programming operation, a maximum number of iterations for an incremental step pulse programming operation, a program verify threshold for a program operation, an initial bias for an incremental step pulse programming operation, a duration for an incremental step pulse programming operation, or the like. A configuration parameter for erasing storage cells, in certain embodiments, may include a step magnitude for an incremental step pulse erase operation, a maximum number of iterations for an incremental step pulse erase operation, an erase verify threshold for an erase operation, an initial bias for an incremental step pulse erase operation, a duration for an incremental step pulse programming operation, or the like. One of skill in the art, in light of this specification, will recognize other configuration parameters for storage cells that may be modifiable by way of an interface.

A configuration parameter for managing, reading from, writing/programming to, and/or erasing storage cells, as described above, may generally be referred to as a storage threshold for the storage cells. For example, a storage threshold, in various embodiments, may include a read voltage threshold, a resistivity threshold, a number of read retries to perform, a maximum number of read retries, a step magnitude for an incremental step pulse programming operation, a maximum number of iterations for an incremental step pulse programming operation, a program verify threshold for a program operation, an initial bias for an incremental step pulse programming operation, a duration for an incremental step pulse programming operation, a step magnitude for an incremental step pulse erase operation, a maximum number of iterations for an incremental step pulse erase operation, an erase verify threshold for an erase operation, an initial bias for an incremental step pulse erase operation, a duration for an incremental step pulse programming operation, or another storage threshold.

The configuration parameter may be set once during initialization of the non-volatile memory media 122, dynamically with each command issued to the non-volatile memory media 122, or during operation of the non-volatile memory media 122 in response to triggers such as read events, error events, or time intervals. The configuration parameter module 150, in one embodiment, proactively sets one or more read thresholds for storage cells of the non-volatile memory media 122 to prevent or reduce errors, or the like. In a further embodiment, the configuration parameter module 150 reactively sets one or more read thresholds for storage cells of the non-volatile memory media 122 based on closed-loop feedback from the storage cells (e.g., the results of one or more soft read operations), to correct one or more data errors for the storage cells, or the like.

The read voltage thresholds or other configuration parameters for the non-volatile memory media 122, in one embodiment, are initially set at a default level that may be defined by a manufacturer. Often such default levels are set to accommodate a large range of general purpose uses of the non-volatile memory media 122. Advantageously, embodiments of the configuration parameter module 150 allow the non-volatile memory media 122 to be used most optimally based on changes or drift of stored read voltage levels over time, due to read disturb, program disturb, temperature, retention time, or other effects. The configuration parameter module 150, in certain embodiments, overrides the default level for read voltage thresholds, or other configuration parameters, setting the read voltage thresholds to a different level based on the results of several soft read operations for storage cells of the non-volatile memory media 122.

A media characteristic for a set of storage cells, in one embodiment, describes an attribute or statistic for a set of particular storage cells, such as a program/erase cycle count for the set of storage cells, a read count for the set of storage cells, a retention time since a previous write for the set of storage cells, a dwell time for the set of storage cells such as a logical or physical erase block (e.g., a time between a program of an erase block and an erase of the erase block), an average of multiple previous dwell times for the set of storage cells, an error statistic for the set of storage cells, or the like. A media characteristic, in another embodiment, may include or relate to an environmental condition or a use of the non-volatile memory device 120 and/or of the non-volatile memory media 110, such as a temperature, a use case (e.g., a cache use case, an archival use case, a server use case, an enterprise use case, a consumer use case), or the like. In another embodiment, the media characteristics include an error statistic for a set of storage cells, such as an uncorrectable bit error rate “UBER,” a raw bit error rate “RBER,” or the like. The media characteristic, in one embodiment, affects or informs the determination of a read threshold for the set of storage cells.

The configuration parameter module 150 may set the read voltage thresholds or other configuration parameters to a level that decreases the amount of errors that the non-volatile memory media 122 encounters when compared to the default level, to a level that increases the amount of errors that may be detected and corrected when compared to the default level, and/or to a level that otherwise improves the utility of the non-volatile memory media 122 when compared to the default level.

The read voltage levels of storage cells, and other configuration parameters, can also shift over time, due to leakage and other disturbances of the non-volatile memory media 122. The rate of leakage can also increase with the wear and age of the non-volatile memory media 122. If the read voltage level of a storage cell shifts past the read voltage threshold, a data error occurs, as the value of the data read from the storage cell is different than the value of the data written to the storage cell. The configuration parameter module 150, in one embodiment, adjusts a read voltage threshold or other configuration parameter for one or more storage cells from the non-volatile memory media 122 to compensate for shifts in the read voltage levels of the storage cells. By proactively and/or dynamically adjusting read voltage thresholds or other configuration parameters, the configuration parameter module 150 can increase the retention rate for and/or the reliability of data stored in the non-volatile memory media 122 and extend the useable lifetime of the non-volatile memory media 122 itself, improving the utility of the non-volatile memory media 122.

In a certain embodiment, the non-volatile memory media 122 of the non-volatile memory device 120 includes a plurality of storage cells. As used herein, a “cell” refers to the smallest physical unit of storage or memory in a non-volatile memory medium 122. In some embodiments, each cell has a physical and/or electrical property which may be altered to encode or otherwise store data. For example, in flash memory, a cell may include a floating gate transistor, and the physical property used to encode data may be the charge stored on the floating gate, a stored read voltage level caused by the charge stored on the floating gate, the threshold voltage Vₜ that is sufficient to make the transistor conduct when applied to the control gate, or the like. As another example, in phase change memory, a cell may be a region of chalcogenide glass, and the physical property used to encode data may be the degree of crystallization of the region, the electrical resistance of the cell, or the like. As described above with regard to non-volatile memory media 122, many types of cells may store data of a non-volatile memory device 120 for use with the configuration parameter module 150.

FIG. 2 depicts one embodiment of a configuration parameter module 150. The configuration parameter module 150 may be substantially similar to the configuration parameter module 150 described above with regard to FIG. 1. In general, as described above, the configuration parameter module 150 may determine soft read data or information for one or more storage cells of the non-volatile memory media 122, determine a read threshold for the storage cell(s) based on the soft read data or information, and configure the non-volatile memory media 122 to use the determined read threshold when accessing data stored in the storage cell(s). In the depicted embodiment, the configuration parameter module 150 includes a soft read module 202, a distribution module 204, and a parameter module 206.

The soft read module 202, in one embodiment, is configured to determine, read, sense, or otherwise obtain soft read data or information for a cell of a non-volatile memory media 122. A soft read, in certain embodiments, is not a standard or regular read operation. A standard or regular read, also known as a hard read, may return a boolean value indicating whether a hard read threshold was satisfied. In contrast, a soft read may return more information than a single boolean value. In some embodiments, the soft read returns a probability or confidence that the corresponding boolean value is accurate. For example, in certain embodiments, a soft read operation may result in soft read data or information comprising a vector that includes both a direction indicating bit value (e.g., positive for a binary zero or negative for a binary one) and a magnitude. The magnitude may indicate a probability or confidence that the direction indicating bit value is correct. In some embodiments, the soft read returns a multiple bit value indicating whether multiple soft read thresholds are satisfied. In other embodiments, the soft read returns information regarding a sub-state in which a stored read voltage level for the cell resides.

In a certain embodiment, the non-volatile memory media 122 of the non-volatile memory device 120 includes a plurality of storage cells. The soft read module 202 may obtain soft read data or information directly or indirectly from the non-volatile memory media 122. For example, the soft read module 202 may receive the soft read data or information from another module or element in the non-volatile memory media device 120. For example, in certain embodiments, the soft read module 202 may receive soft read data or information from an error-correcting code (ECC) decoder 312 (e.g., as depicted in FIG. 3) to minimize overhead. As another example, soft read data or information input to an ECC decoder 312 may be received by the soft read module 202 in parallel to save time and minimize overhead. In a further embodiment, the soft read module 202 may provide soft read data or information to the parameter module 206 and/or the ECC decoder 312.

In some embodiments, the cell comprises a multi-level cell (MLC) or a triple-level cell (TLC) and the soft read module 202 is configured to perform a first set of soft read operations using a first set of soft read voltage thresholds or other configuration parameters and a second set of soft read operations using a second set of soft read voltage thresholds or other configuration parameters. Additional sets of soft read operations (e.g., third, fourth, or the like) using additional sets of soft read voltage thresholds or other configuration parameters may be performed according to the nature of the storage cell. The first set of soft read voltage thresholds or other configuration parameters may be spaced at a first interval and the second set of soft read voltage thresholds or other configuration parameters may be spaced at a second interval.

In certain embodiments, the soft read module 202 is configured to perform different soft read operations using different granularities of soft read voltage thresholds or other configuration parameters. For example, a first soft read operation using broad read voltage spacing may be performed and a subsequent soft read operation using narrow read voltage spacing may be performed. The first soft read operation and the subsequent soft read operation may be centered on the same hard read threshold or on different hard read thresholds.

In some embodiments, the soft read module 202 is configured to issue a soft read command to the non-volatile memory media 122 and receive soft read data or information in response. The soft read module 202 may specify the number of soft read operations that should be performed, the soft read thresholds, the soft read threshold spacing, and/or other parameters used to obtain the soft read data or information.

A soft read command, as used herein, comprises an instruction to perform a soft read operation on a storage cell or group of storage cells. In some embodiments, soft read commands may be provided by the non-volatile memory device 120, the non-volatile memory media controller 126, the non-volatile memory media 122, or the like. In one embodiment, a single soft read command may comprise an instruction to perform a plurality of sub-read operations in response to the single soft read command, for example three sub-read operations, five soft-read operations, or the like. Each soft read operation may itself comprise or cause a plurality of sub-read operations to be performed on the associated set of storage cells (e.g., a logical or physical page, a word line, an error-correcting code (ECC) chunk/code word, or another storage region).

Sending a single soft read command or a set of multiple soft read commands, in certain embodiments, may save time and/or bandwidth on the bus 125 when compared to sending separate standard read commands. For example, a single soft read command may result in three or more sub-read operations, which would otherwise be separately requested and receive separate responses. In further embodiments, a soft read command may specify or include the soft read thresholds, the soft read threshold spacing, and/or other parameters for the multiple sub-read operations used to obtain soft read data or information. In some embodiments, a soft read command may indicate an amount of soft read data or information to be gathered. A soft read command may be issued by the soft read module 202 to one or more of a configuration parameter module 150, a non-volatile memory controller 124, a non-volatile memory media controller 126, a device driver such as an SML 130, a processor 111, and/or other modules or devices supporting a soft read command for the non-volatile memory device 120.

Soft read commands, in certain embodiments, allow more efficient determination of how a stored read voltage level for a storage cell has drifted or changed over time, facilitating determination of an accurate read voltage threshold or other configuration parameter for the storage cell. Without using soft read commands, a non-volatile storage device 120 otherwise may iteratively adjust a read voltage threshold or other configuration parameter and issue a standard (e.g., hard) read command for each iteration to determine a stored read voltage level for the storage cell, to determine an accurate read voltage threshold or other configuration parameters for the storage cell, or the like. In contrast, using a soft read command, in certain embodiments, may minimize time spent determining a stored read voltage level, an accurate read voltage threshold, or the like, may minimize bandwidth on the bus 125, may reduce command overhead, and/or provide other efficiencies over using standard, hard read commands.

For example, in embodiments where each soft read operation performs three reads, fifteen read operations may be performed (e.g., by a non-volatile memory element 123) in response to a controller (e.g., the soft read module 202) issuing only five soft read commands. In embodiments where each soft read operation performs five reads, fifteen read operations may be performed (e.g., by a non-volatile memory element 123) in response to a controller (e.g., the soft read module 202) issuing only three soft read commands. In the example embodiments, the use of soft read commands may result in a significant speed advantage over the fifteen regular read commands needed to obtain the same information.

Soft read data or soft read information, as used herein, comprises data indicating an accuracy or quality of a data value determined for a storage cell (e.g., a probability or confidence that the data value is correct), the relative placement of the data in the storage cell (e.g., a microstate, a stored read voltage level, or the like), or otherwise comprises more data than a single bit data value per storage cell. In one embodiment, soft read data or information may comprise a multi-bit value where each bit indicates whether a corresponding soft read threshold was met. In another embodiment, the soft read data or information may indicate a likelihood that the cell resides in a particular abode or state. In further embodiments, soft read data or information may include an indication of a microstate in which the cell resides.

In one embodiment, the soft read module 202 obtains the soft read data or information in response to a testing or maintenance operation (e.g., a background scan of the non-volatile memory media 122 or the like) and the soft read data or information may be sample data read as part of the testing operation. In a further embodiment, the soft read module 202 obtains the soft read data or information in response to a read request from a storage client 116 and the soft read data or information may correspond to a requested data set. In another embodiment, the soft read module 202 may obtain the soft read data or information in response to a storage capacity recovery event for a set of storage cells as described below with regard to the storage capacity recovery module 310. The soft read module 202 may obtain soft read data or information on each read operation, at predefined intervals, in response to a command or directive from a storage client, or the like. By using the soft read module 202 to obtain soft read data or information in response to read commands, the configuration parameter module 150 may dynamically adjust read thresholds for the non-volatile memory media 122, preventing uncorrectable data errors from occurring, reducing uncorrectable data errors, extending a usable lifetime of the non-volatile memory media 122, or the like. In some embodiments, the soft read module 202 obtains soft read data or information in response to a data error event. For example, the data error event may be a bit error rate exceeding a limit, an ECC decoder module 312 encountering an uncorrectable data error, or the like. The soft read module 202, in one embodiment, may obtain soft read data or information in response to an ECC decoding operation for a set of storage cells by the ECC decoder module 312, as described below.

In certain embodiments, the soft read module 202, when reading a data set of sample data in response to a testing operation, periodically, during monitoring, or the like, may size the sample data set to fit within excess read bandwidth of the non-volatile memory media 122. By sizing sample data to fit within excess read bandwidth of the non-volatile memory media 122, in one embodiment, reading the sample data may not affect a read bandwidth for servicing read requests to the non-volatile memory media 122 or a read throughput of the non-volatile memory media 122. In one embodiment, the soft read module 202 may read a data set from the non-volatile memory media 122 with a greater amount of data than is requested by a read request to provide a greater sample size of bits for the parameter module 206 to use to determine an adjustment to a read voltage threshold or other configuration parameters, or the like. A sample size that is greater than an amount of data requested, in certain embodiments, may improve the accuracy of a read voltage threshold or other configuration parameter adjustment.

In one embodiment, the range of possible values for the data-encoding physical property of a cell is divided into discrete states or abodes, so that each state encodes one or more possible data values. In some embodiments, the states are configured to encode values for a plurality of bits. For example, if a cell stores two bits using four states, each state may encode a different value for the two bits of the cell, such as “11,” “01,” “00,” or “10.” In a further embodiment, the states of a cell may be separated by guard bands. As used herein, a “state” or “abode” refers to a sub-range of possible values for the data-encoding physical property of a cell, so that each state corresponds to a single set of one or more data values.

In some embodiments, reading data from a cell may involve sensing whether the cell's physical property satisfies one or more read thresholds, to determine the cell's state. A read threshold, in various embodiments, may be a voltage threshold, resistivity threshold, or the like, so that many types of read thresholds are possible, corresponding to the various types of non-volatile memory media 122. For example, in one embodiment, a read voltage threshold for a flash memory cell comprising a floating gate transistor may comprise a voltage applied to the control gate, so that sensing whether the transistor conducts when the read voltage threshold is applied determines whether a stored read voltage for the cell is above or below the read threshold. As another example, a read threshold for a phase change memory cell may be a resistivity threshold, and reading data from the cell may include determining whether the resistivity of the cell is above or below the read threshold.

In one embodiment, the number of read thresholds for a cell may be a minimum number for determining which state a cell is in. In a further embodiment, the minimum number may be equal to the number of states per cell, minus one. For example, single-level cell (SLC) flash memory, which uses two states to store one bit per cell, may use one read threshold to determine which state a cell is in. Similarly, multi-level cell (MLC) flash memory, which uses four states to store two bits per cell, may use three read thresholds to determine which state a cell is in, and triple-level cell (TLC) flash memory may use seven read thresholds to determine which of eight states a cell is in, and recover a three-bit data value. Cells with other numbers of states may similarly use a minimum number of read thresholds at boundaries between states to determine the state of a cell. In certain embodiments, a minimum set of read thresholds for determining the state of a cell may be referred to as “hard” read thresholds, and reading data from a cell using hard read thresholds (without additional thresholds) may be referred to as “hard” reading or sensing. In some embodiments, hard read thresholds may be sufficient for reading cells that are not expected to drift near or across the boundaries between states.

However, in some embodiments, a cell's data-encoding physical property may drift near or across a boundary between states. This tendency to drift may become more pronounced due to wear as the cell ages or is used over time. For example, electrical stressing from programming and/or erasing flash memory cells may create defects in an oxide layer, so that charge leaks from a floating gate, through the oxide layer, over time. Programming, erasing, or reading nearby cells may cause similar drift in the data-encoding physical property of a cell. Different types of cells may experience a variety of different types of error-causing phenomena. In some embodiments, a storage cell may be changed from a TLC mode to a MLC mode or a SLC mode as the cell ages to overcome its increased tendency to drift. Similarly, a storage cell may be changed from a MLC mode to a SLC mode to compensate for an increased tendency to drift. As the distance (e.g., voltage difference) between states increases, the storage cell may be less likely to drift into another state.

Errors may occur if a cell drifts from one state into another state, thus changing the data value stored by the cell. Accordingly, an ECC encoder may encode data to be stored by non-volatile memory devices 120 using an error-correcting code, such as a block code, a convolutional code, a Bose-Chaudhuri-Hocquenghem (BCH) code, a low-density parity check (LDPC) code, a Hamming code, a Reed-Solomon code, a turbo code, or the like. An ECC decoder 312 may decode the error-correcting code to detect and/or correct errors, allowing retrieval of the original, unencoded data.

As non-volatile memory technology scales down to smaller feature sizes, cells become more susceptible to error-causing phenomena, such as drift, which may change the value of data stored by the cell. Accordingly, a non-volatile memory system 102 may adjust read thresholds to compensate for drift and/or other error-causing phenomena. For example, in one embodiment, a non-volatile memory system 102 may use a soft read to ascertain a current read voltage level of a storage cell. In some embodiments, the number of read thresholds for a cell may be more than a minimum number for determining which state a cell is in. In certain embodiments, a set of read thresholds that includes more read thresholds than are needed to determine the state of the cell may be referred to as “soft” read thresholds, and reading data from a cell using soft read thresholds may be referred to as “soft” reading or sensing. Similarly, just as the hard read thresholds may correspond to a cell's states, soft read thresholds may correspond to “microstates” for a cell, with greater granularity than the states that encode data values.

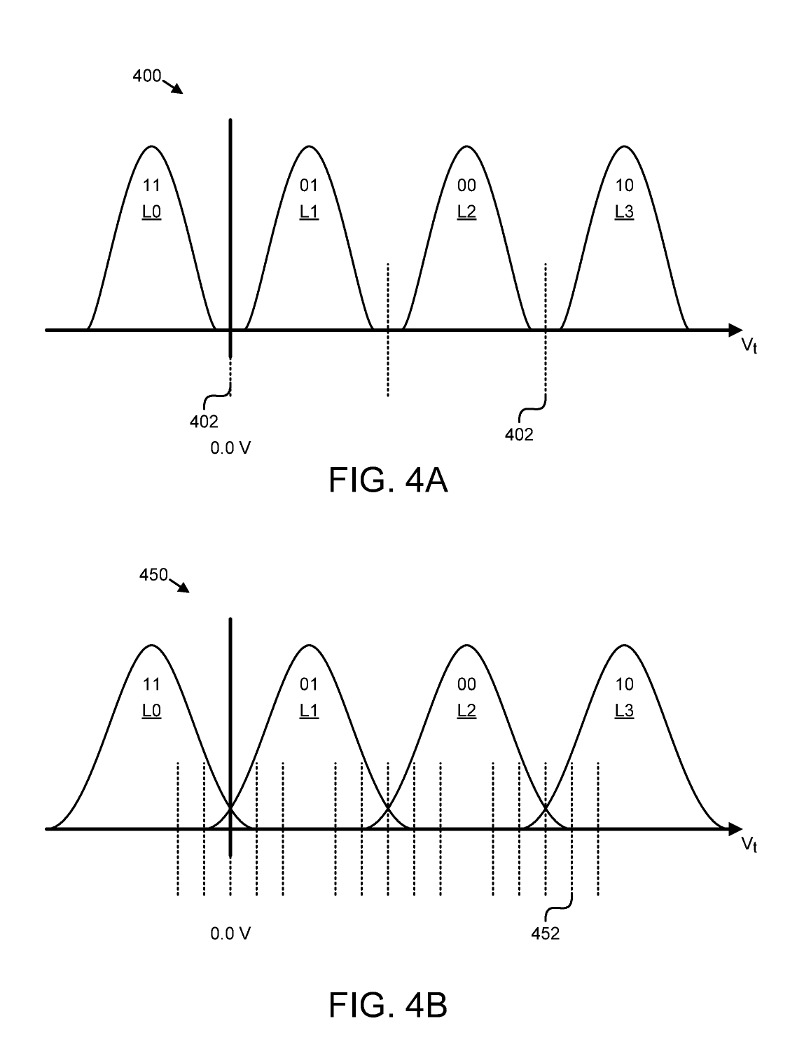

In one embodiment, a set of soft read thresholds may include three read thresholds at or near a boundary between states: one at the boundary between states, and one on either side. In another embodiment, a set of soft read thresholds may include five read thresholds at or near a boundary between states: one at the boundary between states, and two on either side. Additional configurations of soft read thresholds are possible. States, microstates, hard read thresholds, and soft read thresholds are described in greater detail below with regard to FIGS. 4A and 4B.

In one embodiment, the soft read module 202 may determine, read, sense, or otherwise obtain soft read data or information by soft reading or soft sensing, as described above. In a further embodiment, the soft read data or information may include a multiple-bit value, and individual bits of the multiple bit value may indicate whether the cell satisfies corresponding soft read thresholds. For example, in one embodiment, an SLC flash cell may store one bit, and the soft read module 202 may read five bits of soft read data or information, so that each bit indicates whether the cell satisfies one of five soft read thresholds for the cell. In another embodiment, however, the individual bits of soft read data or information may not directly correspond to individual soft read thresholds. For example, in a certain embodiment, three soft read thresholds for a cell may define boundaries between four microstates, and the soft read module 202 may determine two bits of soft read data or information, which are sufficient to indicate the microstate of the cell. It is clear, in light of this disclosure, that many different types and configurations of soft read data or information are possible.

The distribution module 204, in one embodiment, is configured to determine a distribution of read levels, such as read voltage levels, for a set of storage cells from which the soft read module 202 measures, reads, or otherwise obtains soft read data or information. The distribution of read voltages is determined based on the soft read data or information obtained by the soft read module 202. For example, in certain embodiments, a non-volatile memory element 123 may return a distribution of soft read data or information to the soft read module 202 for a page, an erase block, a sector, a storage element, or another set of storage cells. The distribution module 204, in certain embodiments, may estimate or interpolate the actual or approximate stored read voltage levels of a set of storage cells (e.g., a page, a wordline, an erase block, or the like). For example, the soft read module 202, as described above, may issue multiple soft read commands for a set of storage cells, with progressively closer intervals between the soft read voltage thresholds, until the stored read voltage values for the set of cells are known, within a certain range or the like, and may be used by the distribution module 204 in a distribution of read voltage levels. If the actual or approximate distribution of read voltage levels for a set of storage cells (e.g., a page, a wordline, an erase block) is known, in one embodiment, the parameter module 206, described below, may determine one or more optimal read voltage thresholds or other configuration parameters based on the distribution (e.g., a read voltage threshold or other configuration parameter to minimize or eliminate errors for the set of storage cells).

In some embodiments, the soft read module 202 receives the soft read data or information from an ECC decoder 312. In further embodiments, the distribution module 204 may receive information about the corrected data values stored in the set of cells as determined by the ECC decoder 312. The distribution module 204 may use the data values and/or the soft read data or information to determine a distribution of stored voltage levels within the set of cells. In some embodiments, the distribution module 204 provides information regarding the distribution of stored voltage levels within the set of cells to the parameter module 206 for determination of a new read voltage threshold or other configuration parameters. In some embodiments, the distribution module 204 evaluates the distribution of stored voltage levels to determine whether an adjustment to the read voltage threshold(s) or other configuration parameter(s) should be made.

In certain embodiments, the distribution module 204 may determine multiple distributions of read levels for cells in different reliability or health categories. The distribution module 204 may receive media characteristics for the non-volatile memory device 120 from the media characteristic module 304 and determine distribution of voltage levels for storage cells with particular reliability or health characteristics.

As described below with regard to FIG. 4B, in certain embodiments, a plurality of soft read thresholds may be used to obtain soft read data or information for the cell(s). In further embodiments, the distribution module 204 may determine a distribution of read levels by determining whether the measured cell satisfies the various read thresholds. In some embodiments, the distribution module 204 compares the soft read data or information to a known data pattern (e.g., predefined or otherwise known data previously written to a set of storage cells) to determine the distribution model of read levels.

The parameter module 206, in one embodiment, is configured to determine a read voltage threshold or other configuration parameter for a set of storage cells based on the soft read data or information. The soft read data or information may indicate that the read voltage level has drifted above (or below) the hard read voltage threshold and that an adjustment is needed. In some embodiments, the soft read data or information indicates the microstate of the cell and the parameter module 206 may select a new read voltage threshold or other configuration parameter based on the cell's microstate. In some embodiments, the soft read data or information indicates whether individual soft read thresholds are satisfied and the parameter module 206 may select a new read voltage threshold or other configuration parameter based on which soft read thresholds are satisfied. In certain embodiments, the parameter module 206 adjusts the read voltage threshold or other configuration parameter in response to determining a new read voltage threshold or other configuration parameter. In other embodiments, the parameter module 206 provides the new read voltage threshold or other configuration parameter to another module or device, such as the media configuration module 302.

In certain embodiments, a new read voltage threshold or other configuration parameter is selected by iteratively adjusting the read voltage threshold or other configuration parameter and re-reading the set of storage cells until each level has been tested, until an ECC decoder 312 can correct errors in the data set, or the like. In one embodiment, the parameter module 206 stores the new read voltage threshold or other configuration parameters such that the new read voltage threshold or other configuration parameters is persistent for subsequent data reads from the non-volatile memory media 122. In another embodiment, the parameter module 206 uses a search algorithm to determine the read voltage threshold or other configuration parameters. To check each step as part of the search algorithm, the soft read module 202 may re-read the data set in response to each adjustment, and the parameter module 206 may re-determine whether the read bias of the re-read data set deviates from the known bias. The parameter module 206 may re-determine a direction of deviation to further the search and may iteratively readjust the read voltage threshold or other configuration parameter based on the re-determined direction of deviation. Embodiments of iterative adjustment of a read voltage threshold or other configuration parameter are described in co-pending U.S. patent application Ser. No. 13/719,045 entitled “Managing Non-Volatile Media” and filed on Dec. 18, 2012 for Robert Wood, et al., which is hereby incorporated by reference.

The parameter module 206 may base the new read voltage threshold or other configuration parameter on known characteristics of the storage cells, such as an encoding type used for the storage cells, based on a physical and/or electrical architecture of the storage cells, or the like. In another embodiment, for MLC storage cells, the parameter module 206 may determine a new read voltage threshold or other configuration parameter for the MLC storage cells based on a subset of the data stored by the MLC storage cells.

In certain embodiments, the soft read module 202 may read a data set that includes only a subset of the bits stored by a grouping of multi-level storage cells, and the parameter module 206 may determine one or more read voltage thresholds or other configuration parameters for the storage cells based on soft read data or information for the subset of the bits. The parameter module 206, in one embodiment, may request that the data set be re-read with the new read voltage threshold or other configuration parameter. The parameter module 206 may determine whether data is correctly re-read from the storage cells and may adjust the determined read voltage threshold or other configuration parameter accordingly. For example, the parameter module 206 may adjust the new read voltage threshold or other configuration parameter until the data read from the storage cells becomes correctable by an ECC decoder 312, or the like.

In one embodiment, the different multiple channels, storage elements, die, chips, physical erase blocks, groupings of storage cells, or the like within the non-volatile memory media 122, may each have independently adjustable read voltage thresholds or other configuration parameters. The parameter module 206 may determine new read voltage thresholds or other configuration parameters for each of the independent read voltage thresholds or other configuration parameters.

In certain embodiments, the parameter module 206 may determine read voltage thresholds or other configuration parameters based on soft read data or information, instead of or in addition to error information from the ECC decoder module 312, described below. For example, in one embodiment, the parameter module 206 may determine one or more read voltage thresholds or other configuration parameters for a set of storage cells without the ECC decoder module 312 first decoding and error-correcting the data of the set of storage cells, which may reduce an amount of time used to determine read voltage thresholds or other configuration parameters when compared to an iterative, trial-and-error process which may check a sequence of possible read voltage threshold using error information (e.g., an error rate, RBER, UBER, an indicator of bits in error, corrected data, or the like) to select a read voltage threshold or other configuration parameters that minimizes the errors. For example, by first determining, adjusting, and/or setting one or more read voltage thresholds or other configuration parameters for a set of cells and then decoding the data of the cells for error correction, in certain embodiments, the parameter module 206 may reduce a number of errors in the data into a range which the ECC decoder module 312 is configured to correct, while the data errors may otherwise have been uncorrectable.

FIG. 3 depicts another embodiment of a configuration parameter module 150. The configuration parameter module 150, in certain embodiments, may be substantially similar to the configuration parameter module 150 described above with regard to FIG. 1 and/or FIG. 2. In the depicted embodiment, the configuration parameter module 150 includes a soft read module 202, a distribution module 204, and a parameter module 206 which may be configured substantially as described above with regard to FIG. 2. The configuration parameter module 150, in the depicted embodiment, also includes a media configuration module 302, a media characteristic module 304, a health module 306, a write threshold module 308, a storage capacity recovery module 310, and an ECC decoder module 312.

The media configuration module 302, in one embodiment, is configured to modify or configure the non-volatile memory media 122 to use the determined read threshold or other configuration parameter, for example, when reading data values from a set of storage cell. In one embodiment, the media configuration module 302 stores the new read threshold or other configuration parameter such that the new read threshold or other configuration parameters is persistent for subsequent data reads from the non-volatile memory media 122. In general, the media configuration module 302 sets and adjusts read thresholds or other configuration parameters, such as read voltage thresholds, resistivity thresholds, or the like. In various embodiments, the set of cells may refer to any grouping of cells of the non-volatile storage media 122 which includes the cell or cells from which the soft read module 202 obtained soft read data or information. For example, in certain embodiments, the set of cells may be a physical or logical page, physical or logical erase block, chip, die, die plane, plurality of chips, dies, or die planes, or the like.

As described above, a read threshold is a configuration parameter of a set of storage cells that is modifiable by way of an interface. An interface for modifying the read threshold or other configuration parameter may include a programmable data register, a command interface of a control bus for the non-volatile memory media 122, an API of a device driver of the non-volatile memory device 120, a control parameter for the non-volatile memory controller 124, or the like.

The media configuration module 302 uses an interface of a set of storage cells to configure the set of storage cells. The interface may comprise a publicly known interface or a proprietary interface. The media configuration module 302 may configure a set of storage cells by programming a data register, by sending a command over a command interface of a control bus for the non-volatile memory media 122, by calling an API of a device driver of the non-volatile memory device 120, by setting a control parameter for the non-volatile memory controller 124, or otherwise configuring the set of storage cells. For example, in certain embodiments, the media configuration module 302 may configure a set of storage cells to use a read threshold or other configuration parameter determined by the 204 in response to a read request for the storage cells.

The media configuration module 302, in one embodiment, adjusts the read voltage threshold or other configuration parameter using a procedure or command provided by a manufacturer of the non-volatile memory media 122. For example, in one embodiment, the media configuration module 302 may adjust the read voltage threshold or other configuration parameter by writing a value to a settings register of the non-volatile memory media 122, sending a read voltage threshold parameter or other configuration parameter to the non-volatile memory media 122, or otherwise communicating an adjustment to a read voltage threshold or other configuration parameter to the non-volatile memory media 122.

The media configuration module 302, in a further embodiment, may configure only a subset of one or more abodes of a set of storage cells to use a read threshold or other configuration parameter. For example, if a read threshold or other configuration parameter for an abode has little or no change from a previous level, from a default level, or the like, the media configuration module 302 may configure one or more other abodes without configuring the abode with little or no change in the read threshold or other configuration parameter. In certain embodiments, read thresholds or other configuration parameters for different abodes of a set of storage cells may be set by writing the read thresholds or other configuration parameters to different registers associated with the different abodes, and the media configuration module 302 may set read thresholds or other configuration parameters only to registers for which the levels have changed. In other embodiments, the media configuration module 302 may set read thresholds or other configuration parameters for each abode of a set of storage cells.

The media configuration module 302 may move each of the multiple read voltage thresholds or other configuration parameters together or it may move them independently. In certain embodiments, the media configuration module 302 may configure storage cells one storage region at a time, writing configuration parameter settings to registers for a group or set of pages, a physical erase block, a logical erase block, a wordline, an ECC chunk/code word, a chip, a die, a plane in a die, or another storage region. In certain embodiments, the media configuration module 302 may configure storage cells by storing configuration parameter settings in a bank cache such as a buffer or the like for the non-volatile memory media 122. In a further embodiment, the media configuration module 302 may configure storage cells using a read threshold or other configuration parameter override table or other override metadata configured, scaled, or otherwise structured according to an architecture of the non-volatile memory media 122.

In a certain embodiment, the program/erase cycle count and the retention time for the set of cells may significantly affect the distribution of microstates for a set of cells, and the configuration parameter module 150 may base a frequency of configuration parameter calibration on a reliability or cell health indicator, such as the program/erase cycle count, the retention time for the set of cells, and the like. For example, in one embodiment, reliability categories may be defined by program/erase cycle counts of 1,000, 2,000, 3,000, or the like, and by retention times of 1 month, 2 months, 3 months, or the like. Different configuration parameter calibration frequencies could be defined for different program/erase cycle counts and retention times in different embodiments. In other embodiments, however, program/erase cycle count and/or retention time may be less significant, and the frequency of configuration parameter calibration may be based on another reliability indicator or combination of reliability indicators.

The media characteristic module 304, in one embodiment, is configured to provide one or more media characteristics for the non-volatile memory device 120 to the parameter module 206. In some embodiments, the media characteristic module 304 may communicates with the soft read module 202 to provide age related information used by the soft read module 202 to obtain soft read data or information. The soft read module 202 may adjust soft read parameters, such as a number of soft read operations used to determine soft read data or information, a soft read threshold spacing, or the like. In some embodiments, the media characteristic module 304 may communicate with the parameter module 206 which may determine a new read threshold based at least partially on the one or more media characteristics.

The one or more media characteristics for the non-volatile memory device 120, in one embodiment, include characteristics that may affect read voltages or other configuration parameters of storage cells of the non-volatile memory device 120. For example, in certain embodiments, the one or more media characteristics may include a temperature for the non-volatile memory device 120, an error rate for the non-volatile memory device 120 (such as an UBER, a RBER, or the like), a program/erase cycle count for the non-volatile memory device 120, an age of the non-volatile memory device 120, and/or other characteristics.

The health module 306, in one embodiment, is configured to determine whether the read voltage threshold or other configuration parameter for a particular cell or set of cells has been moved or adjusted beyond a health threshold. For example, the read voltage threshold or other configuration parameter may be moved or adjusted by the parameter module 206 or the like. The health threshold may relate to, or be based on, the reliability and/or utility of the particular cell or set of cells for storing data. For example, an amount that a read voltage threshold or other configuration parameter has been adjusted may indicate a health of a set of storage cells, degradation or wear of a set of storage cells, or the like. The health module 306 may further be configured to initiate a maintenance operation in response to a read voltage threshold or other configuration parameter satisfying the health threshold.

The maintenance operation may include one or more of a retirement operation for the set of cells containing the particular cell, a storage capacity recovery operation, and the like. A retirement operation, as used herein, comprises ceasing to use a storage cell or a set or storage cells of the non-volatile memory media 122 to store data. The health module 306 may retire a cell, or set of cells (e.g., a logical or physical page, a logical or physical erase block, or the like), when the cell or set of cells is no longer able to reliably retain a stored value. In one embodiment, a retirement operation includes associating an indicator with a set of cells comprising the storage cell, such as a physical or logical erase block, that indicates the erase block or other set of cells is retired and is not to be used. In further embodiments, a retirement operation may include relocating valid data of the set of cells to a new location (e.g., copying data forward to a different erase block at an append point of a sequential, log-based writing structure, or the like). A storage capacity recovery operation, as used herein, comprises reclaiming a set of storage cells so that the cells may be reused for other data, for other storage operations, or the like. In one embodiment, a storage capacity recovery operation includes erasing the storage cells so that new data may be stored/programmed thereon. In further embodiments, a storage capacity recovery operation may include relocating valid data from the storage cells to different storage cells at a new location. In some embodiments, the maintenance operation includes converting the particular cell (or a set of cells including the particular cell) from a multi-level mode to a single-level mode, for example, using an MLC storage cell in an SLC mode, with a single read voltage threshold and storing a single bit of data, instead of multiple bits.

The write threshold module 308, in one embodiment, is configured to set a write threshold, such as a program voltage level for writing data to the storage cells of the non-volatile memory media 122. The write threshold may be based on the new read voltage level determined by the parameter module 206 or the like. The write threshold may comprise a programming voltage that specifies the minimum or maximum voltage used to program or change a state of a storage cell, a step magnitude for an incremental step pulse programming operation, a maximum number of iterations for an incremental step pulse programming operation, a program verify threshold for a program operation, an initial bias for an incremental step pulse programming operation, or the like. In one embodiment, the write threshold module 308 may be integrated with the media configuration module 302.

The storage capacity recovery module 310 is configured to preserve valid data from a set of storage cells (e.g., a physical or logical erase block) comprising a cell for which the soft read module 202 obtains data. The data preservation may be in response to the soft data information indicating a need to perform a maintenance operation, in response to the health module 306 determining a read voltage threshold or other configuration parameter has been moved beyond a health threshold, or the like. In some embodiments, the storage capacity recovery module 310 also initiates a maintenance operation, such as a storage capacity recovery operation, or the like. The storage capacity recovery module 310 may coordinate with the health module 306 to perform the maintenance operation or may act independently.

In one embodiment, the storage capacity recovery module 310 recovers storage capacity of physical non-volatile memory media 122 corresponding to data that is marked as invalid, such as data invalidated by a subsequent write request for one or more logical addresses of the data. The storage capacity recovery module 310, in certain embodiments, recovers storage capacity of physical non-volatile memory media 122 corresponding to invalid data opportunistically. For example, the storage capacity recovery module 310 may recover storage capacity in response to a storage capacity recovery event, such as a lack of available storage capacity, a percentage of data marked as invalid reaching a predefined threshold level, a consolidation of valid data, an error detection rate for a section of physical non-volatile memory media 122 reaching a threshold value, performance crossing a threshold value, a scheduled garbage collection cycle, identifying a section of the physical non-volatile memory media 122 with a high amount of invalid data, identifying a section of the physical non-volatile memory media 122 with a low amount of wear, a determination by the health module 306, or the like.

In one embodiment, the storage capacity recovery module 310 relocates and preserves valid data that is in a section of the physical non-volatile memory media 122 in the non-volatile memory device 120 that the storage capacity recovery module 310 is recovering to preserve the valid data (e.g., a logical or physical erase block of storage cells). In one embodiment, the storage capacity recovery module 310 is part of an autonomous garbage collector system that operates within the non-volatile memory device 120. This allows the non-volatile memory device 120 to manage data to provide wear leveling so that data is systematically spread throughout the solid-state non-volatile memory media 122, or other physical storage media, to improve performance, data reliability, to avoid overuse and underuse of any one location or area of the solid-state non-volatile memory media 122, to lengthen the useful life of the solid-state non-volatile memory media 122, or the like.

The storage capacity recovery module 310, upon recovering a section of the physical non-volatile memory media 122, allows the non-volatile memory device 120 to re-use the section of the physical non-volatile memory media 122 to store different data. In one embodiment, the storage capacity recovery module 310 adds the recovered section of physical non-volatile memory media 122 to an available storage pool for the non-volatile memory device 120, or the like. The storage capacity recovery module 310, in one embodiment, erases existing data in a recovered section. In a further embodiment, the storage capacity recovery module 310 allows the non-volatile memory device 120 to overwrite existing data in a recovered section. Whether or not the storage capacity recovery module 310, in one embodiment, erases existing data in a recovered section may depend on the nature of the physical non-volatile memory media 122. For example, Flash media requires that cells be erased prior to reuse where magnetic media such as hard drives does not have that requirement. In an embodiment where the storage capacity recovery module 310 does not erase data in a recovered section, but allows the non-volatile memory device 120 to overwrite data in the recovered section, the storage capacity recovery module 310, in certain embodiments, may mark the data in the recovered section as unavailable to service read requests so that subsequent requests for data in the recovered section return a null result or an empty set of data until the non-volatile memory device 120 overwrites the data.

In one embodiment, the storage capacity recovery module 310 recovers storage capacity of the non-volatile memory device 120 one or more storage divisions at a time. A storage division, in one embodiment, includes a logical or physical erase block or other predefined division. For flash memory, an erase operation on an erase block writes ones to every bit in the erase block. This may be a lengthy process compared to a program operation which starts with a location being all ones, and as data is written, some bits are changed to zero. However, where the solid-state storage 122 is not flash memory or has flash memory where an erase cycle takes a similar amount of time as other operations, such as a read or a program, the non-volatile memory media controller 126 may erase the data of a storage division as it invalidates or deletes data, instead of the storage capacity recovery module 310.

In one embodiment, allowing data to be marked as invalid rather than actually erased and allowing the storage capacity recovery module 310 to recover the physical media 122 associated with invalid data, increases efficiency because, as mentioned above, for flash memory and other similar storage an erase operation may take a significant amount of time. Allowing the storage capacity recovery module 310 to operate autonomously and opportunistically within the non-volatile memory device 120 provides away to separate erase operations from reads, writes, and other faster operations so that the non-volatile memory device 120 operates efficiently.

In certain embodiments, the storage capacity recovery module 310 may perform storage capacity recovery during idle or low workload times of the non-volatile memory device 120, a device driver for the non-volatile memory device 120, or the like. The storage capacity recovery module 310 may select a storage region (e.g., a logical or physical erase block) for storage capacity recovery that has a high-degree of invalid data, or the like. In a further embodiment, the storage capacity recovery module 310 may also select storage regions for storage capacity recovery based on a “coldness” of data in the storage region (e.g., an amount of time since data has been modified), thereby minimizing a probability that the data will be selected for storage capacity recovery in the future.

In one embodiment, the ECC decoder module 312 may decode data (e.g., an ECC code word or chunk) using an ECC decoding operation to correct one or more errors (e.g., data errors, bit errors) in the data. As described above, an ECC encoder may encode data to be stored by the non-volatile memory device 120 using an error-correcting code, such as a block code, a convolutional code, a Bose-Chaudhuri-Hocquenghem (BCH) code, a low-density parity check (LDPC) code, a Hamming code, a Reed-Solomon code, a turbo code, or the like. The ECC decoder module 312 may decode the error-correcting code to detect and/or correct errors, allowing retrieval of the original, unencoded data.

The ECC decoder module 312, in one embodiment, may comprise a soft-decision decoder configured to correct data based at least partially on soft read data or information as described above with regard to the soft read module 202, either directly or indirectly, such as an LDPC decoder, a Viterbi decoder, a turbo code decoder, or the like. In one embodiment, the ECC decoder module 312 may use soft read data or information itself, directly, for error detection and/or correction. In a further embodiment, the ECC decoder module 312 may map soft read data or information to one or more log-likelihood ratio (LLR) values, or the like, which the ECC decoder module 312 may use for error detection and/or correction.

In one embodiment, the type of soft-decision ECC decoder may depend on the type of error correcting code an ECC encoder for the data uses; soft-decision decoders are available for many different error correcting codes. In one embodiment, the ECC decoder module 312 may use a soft-decision ECC decoder implemented in software, such as in a driver or SML 130. In another embodiment, the ECC decoder module 312 may use a soft-decision ECC decoder implemented in hardware, such as in a field-programmable gate array (FPGA) or application-specific integrated circuit (ASIC) for a non-volatile memory media controller 126, a non-volatile memory media controller 126, or the like. In certain embodiments, the ECC decoder module 312 may use a soft-decision ECC decoder implemented using a combination of hardware and software elements.

The ECC decoder module 312 may be configured to decode data stored by a set of cells based on soft read data or information, LLR values, or the like for the set of cells. In various embodiments, a means for an error-correcting code decoding operation using soft read data or information may include an ECC decoder module 312, a configuration parameter module 150, a non-volatile memory controller 124, a non-volatile memory media controller 126, a device driver such as an SML 130, a processor 111, a read pipeline, other logic hardware and/or other executable code stored on a computer readable storage medium. Other embodiments may include similar or equivalent means for an error-correcting code decoding operation using soft read data or information.

In certain embodiments, the ECC decoder module 312 may cooperate with the soft read module 302 to decode or correct data of a set of storage cells based on soft data or information for the set of storage cells. For example, in one embodiment, original data may form a message that is encoded using the error correcting code to form an ECC code word or chunk. In a further embodiment, the data values forming the ECC code word may be stored by cells in a set of cells (e.g., one or more ECC code words may be stored in a logical or physical page, a logical or physical erase block, or the like). In certain embodiments, the soft read module 302 may determine soft read data or information for each cell in the set of cells. In some embodiments, the ECC decoder module 312 may translate the soft read data or information to an LLR value using an LLR mapping or the like. In further embodiments, the ECC decoder module 312 may use the soft read data or information, the LLR values, or the like as inputs for a soft-decision ECC decoder to decode the code word and recover the original message.

As described above, the parameter module 206, in certain embodiments, determines, adjusts, and/or sets one or more read voltage thresholds or other configuration parameters for a set of storage cells using soft read data or information obtained by the soft read module 202. In one embodiment, the ECC decoder module 312 may cooperate with the soft read module 202 and/or the parameter module 206 to share soft read data or information for a set of storage cells, thereby reducing a number of accesses of (e.g., reads from) the set of storage cells. Means for providing and/or receiving soft read data or information may include a soft read module 202, a parameter module 206, an ECC decoder module 312, a bus 125, 127, an API, a data register, a non-volatile memory element 123, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for reading soft read data or information.

For example, in one embodiment, the soft read module 202 may issue a soft read command to a non-volatile memory element 123 for an ECC decoding operation of the ECC decoder module 312, for a set of storage cells, and the soft read module 202 may provide the resulting soft read data or information to both the parameter module 206 and the ECC decoder module 312, so that the soft read data or information is used for both the ECC decoding operation and for determining one or more read voltage thresholds or other configuration parameters. In another embodiment, the distribution module 204 may determine one or more read voltage thresholds or other configuration parameters for a set of storage cells using soft read data or information and may provide the soft read data or information to the ECC decoder module 312 for an ECC decoding operation.

By first setting optimal read voltage thresholds or other configuration parameters and then performing error correction, in certain embodiments, a number of errors in the data may be reduced by using the optimal read voltage thresholds or other configuration parameters rather than default read voltage thresholds or other configuration parameters. Further, in one embodiment, since the parameter module 206 may determine read voltage thresholds or other configuration parameters based on soft read data or information, instead of or in addition to error information from the ECC decoder module 312, the parameter module 206 may determine one or more read voltage thresholds or other configuration parameters for a set of storage cells without the ECC decoder module 312 first decoding and error-correcting the data, which may reduce an amount of time used to determine read voltage thresholds or other configuration parameters when compared to an iterative process checking a sequence of possible read voltage threshold using error information (e.g., an error rate, RBER, UBER, an indicator of bits in error, corrected data, or the like). For example, by first determining, adjusting, and/or setting one or more read voltage thresholds or other configuration parameters for a set of cells and then decoding the data of the cells for error correction, in certain embodiments, a number of errors in the data may be reduced into a range which the ECC decoder module 312 is configured to correct, while the data errors may otherwise have been uncorrectable. In a further embodiment, the ECC decoder module 312 may use soft read data or information to correct one or more errors in data and may provide the soft read data or information to the parameter module 206 for determining one or more read voltage thresholds or other configuration parameters. The parameter module 206 and the ECC decoder module 312, in various embodiments, may operate in parallel, in series, or in another configuration.

FIG. 4A depicts a graph 400 of a distribution for cells of a non-volatile memory media 122. In the depicted embodiment, the non-volatile memory media 122 is an MLC flash memory medium in which each cell has four states, but various types of memory and numbers of states per cell may be used in other embodiments. In the depicted embodiment, the data-encoding physical value of each cell is the stored read voltage of the cell. Data is stored in each cell by changing the amount of stored charge in the floating gate, which determines the stored read voltage for the cell and within which abode or state (e.g., the depicted L0, L1, L2, and L3 abodes) the stored read voltage falls.

In the depicted embodiment, hard read thresholds 402 (e.g., Vt) divide the range of possible stored read voltage values for a cell into states L0, L1, L2, and L3, where L0 is the erased state. A read threshold voltage 402 (e.g., Vt) is applied to the control gate of the cell, and if the applied read threshold voltage 402 is sufficient to make the channel of the floating gate transistor conductive, the stored read voltage for the cell is above the applied read threshold voltage 402. If the stored read voltage for a cell is below the first hard read threshold 402, the cell is in the L0 state. If the stored read voltage for a cell is above the first hard read threshold 402 but below the second hard read threshold 402, the cell is in the L1 state, and so on. In some embodiments, the erased state L0 may correspond to a negative stored read voltage.

In one embodiment, an encoding maps states onto data values. For example, in the depicted embodiment, a Gray code encoding maps the four states L0, L1, L2, and L3 to the data values “11,” “01,” “00,” and “10,” respectively, so that the cell stores two bits of information. Cells of non-volatile memory media may store data using many other encodings.

The graph 400 depicts the distribution of stored read voltage values for a set of cells, representing the stored read voltage values occurring for the set of cells, a random selection from the set of cells, or the like. The graph 400 depicts a uniform distribution among states L0-L3. In practice, the distribution of states for a set of cells may not be uniform. For example, if a long string of zeros is written to a set of cells, more cells may be in the L2 state, which encodes “00” than in the other states. However, data compression or whitening algorithms may make the distribution of states substantially uniform over a large set of cells.

Although the distribution may be substantially uniform among states L0-L3, it is depicted as forming a bell-shaped peak in each state. In some embodiments, a cell may be programmed by issuing voltage pulses that move a stored read voltage level for the cell to or near a target voltage in the middle of the range of voltages that defines the state. Thus, a bell-shaped peak may be centered on the target programming voltage, or the like. The width of the peaks may be affected by variations in the cells and the programming process, or by error-causing phenomena such as read disturbs, program disturbs, stress-induced leakage current, or the like. Although symmetric, bell-shaped peaks are shown, skewed distributions and other distributions are possible. Over time, the distributions may widen or skew as the stored read voltage of cells drift from their originally programmed values. In the depicted embodiment, the peaks do not significantly overlap the boundaries between states, indicating that cells are not likely to drift into adjacent states. Therefore, hard read thresholds 402 may be sufficient to determine what data value was originally written to a cell, based on the cell's current state, and no read threshold correction is needed.

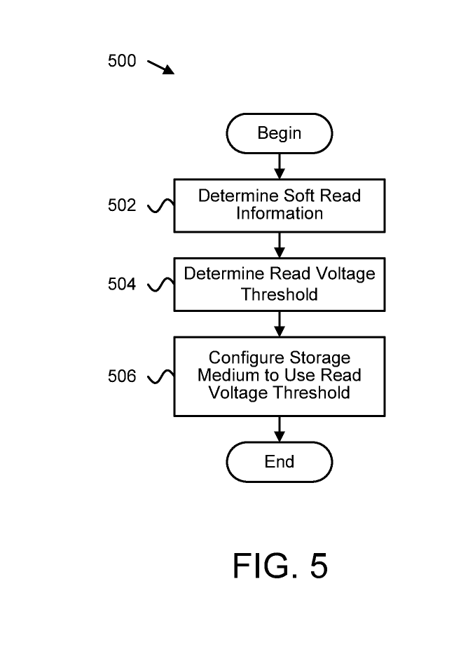

FIG. 4B depicts a graph 450 of another distribution for the same set of cells as FIG. 4A. The same boundaries define states L0, L1, L2, and L3, encoding data values “11,” “01,” 00,” and “10,” respectively, as described above. However, the peaks are wider in FIG. 5B than in FIG. 5A, and significantly overlap each other. Because the peaks overlap, there is a substantial likelihood that a cell programmed into one state may drift into an adjacent state. (The distribution is depicted as a set of overlapping peaks to emphasize the possibility that a cell may drift into an adjacent state; an actual distribution may be the sum of the individual peaks).

In FIG. 4B, the peaks have widened, and the reliability category of the peaks may have changed due to an increased program/erase cycle count, increased retention time, or other characteristics of the set of cells that may cause the stored read voltage values to drift. Accordingly, hard read thresholds 402 may be insufficient to determine what data value was originally written to a cell, based on the cell's current state. Therefore, in the depicted embodiment, soft read thresholds 452 divide the range of possible stored read voltage values into microstates that are smaller than the states. The soft read thresholds 452 include five read thresholds at or near each of the three boundaries between states, so fifteen soft read thresholds 452 are depicted. Although five soft read thresholds 452 are depicted with uniform spacing at each of the boundaries between states, other different numbers of soft read thresholds 452 and spacing for soft read thresholds 452 may be used in other embodiments, depending on the desired soft read data or information, such as two soft read thresholds 452, three soft read thresholds 452, four soft read thresholds 452, ten soft read thresholds 452, or another predetermined number of soft read thresholds 452.

Microstates defined between the soft read thresholds 452 have a finer granularity than the states or abodes, because of the increased number of soft read thresholds 452. The width of various microstates, however, may vary as shown by the graph 450 due to varying distances between soft read thresholds. For example, in the depicted embodiment, the soft read thresholds 452 are closely spaced near boundaries between states, but widely spaced elsewhere, so microstates may be smaller near the edges of peaks, but larger near the peaks' centers.

FIG. 5 depicts one embodiment of a method 500 for determining read thresholds for a non-volatile memory device. The method 500 begins, and the soft read module 202 determines 502 soft read data or information for a cell of a non-volatile memory media 122. The soft read data or information may be determined directly from the cell or indirectly from another device or module in the non-volatile memory device 120. In some embodiments, the soft read data or information indicates whether certain soft read thresholds are met. In some embodiments, the soft read data or information indicates a microstate in which the storage cell resides. Means for reading soft read data or information may include a soft read module 202, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for reading soft read data or information.

After obtaining the soft read data or information, the method 500 continues and the parameter module 206 determines 504 a read voltage threshold or other configuration parameter using the soft read data or information. In some embodiments, the parameter module 206 determines 504 the read voltage threshold or other configuration parameter by selecting a soft read threshold based on which soft read thresholds were satisfied. In some embodiments, the read voltage threshold or other configuration parameter is based on the microstate in which the storage cell resides. Means for determining the read voltage threshold or other configuration parameter may include a parameter module 206, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining a read voltage threshold or other configuration parameter.

The method 500 continues with the media configuration module 302 modifying or configuring 506 the non-volatile memory media 122 to use the determined 504 read voltage threshold or other configuration parameter. In some embodiments, the parameter module 206 configures 506 the non-volatile memory media 122 to use the determined 504 read voltage threshold or other configuration parameter during or in association with a subsequent read operation for the storage cell. In some embodiments, the health module 306 uses the read voltage threshold or other configuration parameter to analyze a health state of the device. In some embodiments, the health module 306 uses the read voltage threshold or other configuration parameter to determine whether a maintenance operation should be performed on the storage cell. Means for configuring the non-volatile storage medium to use the determined read voltage threshold or other configuration parameter may include a media configuration module 302, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for configuring a storage medium.

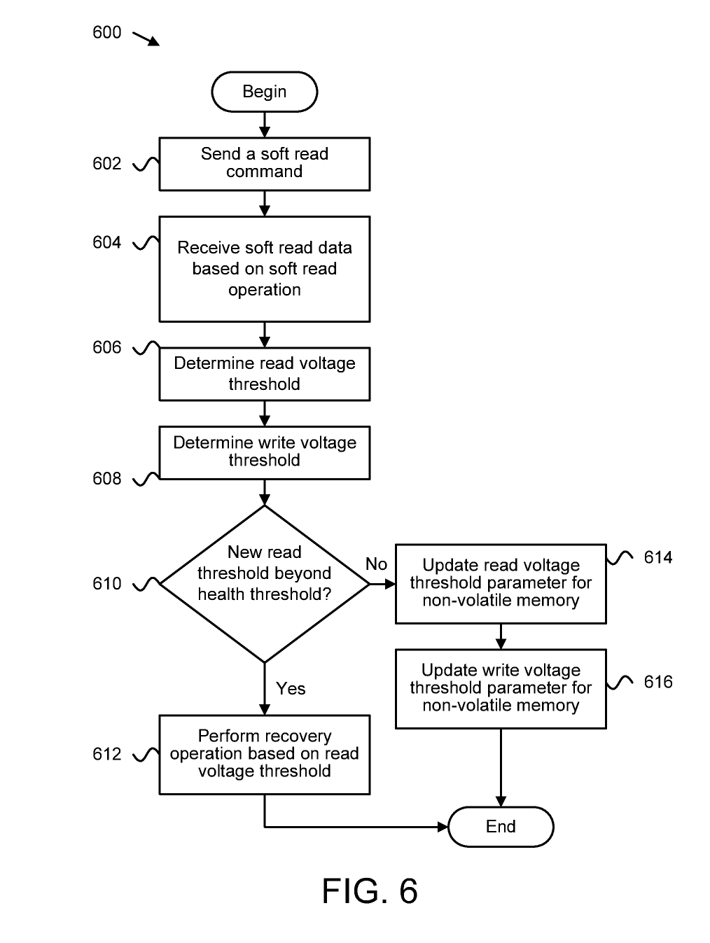

FIG. 6 depicts another embodiment of a method 600 for determining read thresholds for a non-volatile memory device. The method 600 begins and an ECC decoder 312 (e.g., of the non-volatile memory controller 124, the non-volatile memory media controller 126, the SML 130, the soft read module 202, or the like) sends 602 a soft read command for a storage cell. By sending a single soft read command, the method 600, in certain embodiments, may save time and bandwidth on bus 125 as compared to sending standard read commands. The ECC decoder 312 may send 602 the soft read command to a non-volatile memory medium 122, a configuration parameter module 150, a non-volatile memory controller 124, a non-volatile memory media controller 126, a device driver such as an SML 130, a processor 111, or the like. In some embodiments, the soft read command specifies soft read voltages and/or a number of soft read operations to be performed. In certain embodiments, the soft read command indicates a hard read threshold on which the soft read operations are centered. Means for sending the soft read command may include a soft read module 202, an ECC decoder 312, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for sending a soft read command.

The method 600 continues with the ECC decoder 312 receiving 604 soft read data or information based on a soft read operation performed by a memory element (e.g., a NAND chip, such as non-volatile memory element 123) in response to the soft read command received over an interface (e.g., the bus 127, the bus 125, the block I/O interface 131, the SML interface 132, or the like). The received 604 soft read data or information, in certain embodiments, corresponds to results from the soft read operation. For example, the soft read command sent 602 by the ECC decoder 312 may cause the memory element 123 to automatically perform three or more sub-read operations, and the results of the sub-read operations may be processed and/or returned to the ECC decoder 312 as the soft read data or information. A soft read operation may use a plurality of soft read thresholds for the storage cell. While the depicted embodiment includes a single soft read command 602, as described above, in other embodiments, the ECC decoder 312 may use multiple soft read commands 602, each of which may cause the associated non-volatile memory element 123 to perform multiple sub-reads.

The result of the soft read operation comprises soft read information and/or soft read data. In some embodiments, the soft read data or information indicates a sign (e.g., positive or negative) and a magnitude. In another embodiment, the soft read data or information indicates whether certain soft read thresholds are met. In some embodiments, the soft read data or information indicates a microstate in which the storage cell resides. Means for performing the plurality of soft read operations may include a soft read module 202, an ECC decoder 312, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for performing the plurality of soft read operations.

After obtaining the soft read data or information, the method 600 continues with the parameter module 206 determining 606 a read voltage threshold or other configuration parameter using the soft read data or information. In some embodiments, the parameter module 206 determines 606 the read voltage threshold or other configuration parameter by selecting a hard read threshold based on which soft read thresholds were satisfied. In some embodiments, the parameter module 206 determines 606 the read voltage threshold or other configuration parameter based on a microstate in which a stored read voltage level for the storage cell resides. Means for determining the read voltage threshold or other configuration parameter may include a distribution module 204, a parameter module 206, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining the read voltage threshold or other configuration parameter.

In certain embodiments, the method 600 includes the write threshold module 308 determining 608 a write voltage threshold for the storage cell. The write threshold module 308 may determine 608 a write voltage threshold based on the determined 606 read voltage threshold or other configuration parameter and/or based on the soft read data or information. Means for determining the write voltage threshold may include write threshold module 308, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining the write voltage threshold.

The method 600 continues and the health module 306 compares 610 the new (e.g., determined 606) read threshold to a health threshold. In some embodiments, the health threshold is indicative of a problem with the storage cell. In some embodiments, the health threshold is a range of voltage levels that indicate degradation of the storage cell. Means for comparing the new read voltage threshold or other configuration parameter to the health threshold may include a health module 306, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for comparing the new read voltage threshold or other configuration parameter to the health threshold.

If the new read threshold satisfies the health threshold, the storage capacity recovery module 310 performs 612 a maintenance operation on the storage cell. Examples of a maintenance operation include, but are not limited to, a retirement operation, a storage capacity recovery operation, a conversion from a multi-level mode to a single-level mode for the storage cell, and the like. The method 600 then ends. Means for performing a maintenance operation may include a storage capacity recovery module 310, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for performing a maintenance operation.

If the new read threshold does not satisfy the health threshold, the media configuration module 302 updates 614 a read voltage threshold parameter or other configuration parameter for the non-volatile memory media 122. In some embodiments, the new read voltage threshold or other configuration parameter replaces a default read voltage threshold or other default configuration parameter. In some embodiments, the new read voltage threshold or other configuration parameter replaces a previously modified read voltage threshold or other configuration parameter. Means for updating a read voltage threshold parameter or other configuration parameter may include a media configuration module 302, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for updating a read voltage threshold parameter or other configuration parameter.

The method 600 may also include the write threshold module 308 updating 616 a write voltage threshold parameter for the non-volatile memory media 122. In some embodiments, the new write voltage threshold replaces a default write voltage threshold. In some embodiments, the new write voltage threshold replaces a previously modified write voltage threshold. The method 600 then ends. Means for updating a write voltage threshold parameter may include a write threshold module 308, a media configuration module 302, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for updating a write voltage threshold parameter.

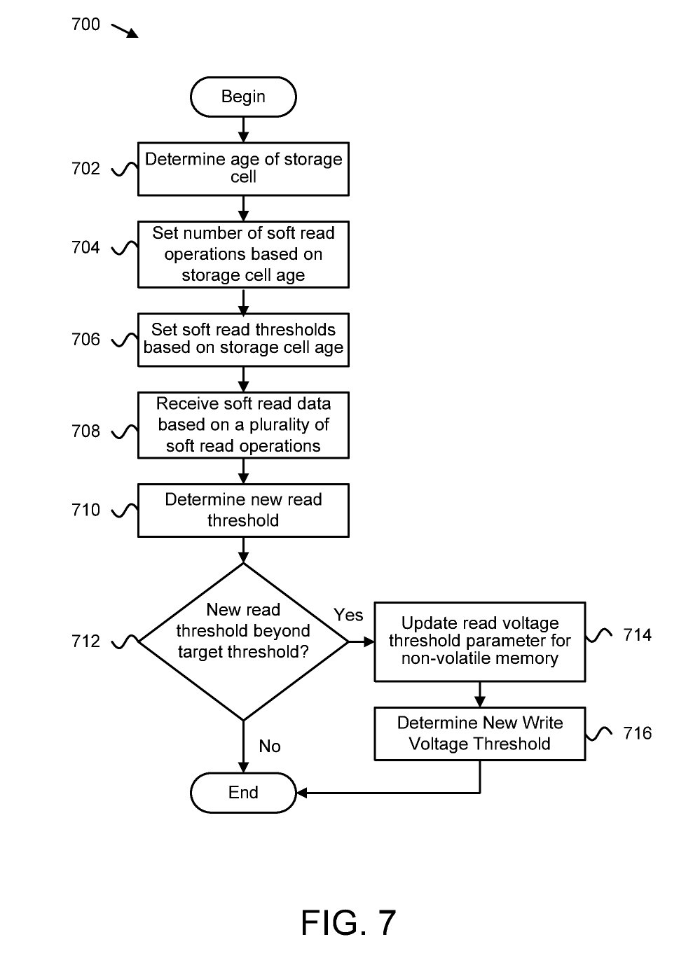

FIG. 7 depicts another embodiment of a method 700 for determining read thresholds for a non-volatile memory device. The method 700 begins and the media characteristic module 304 determines 702 an age parameter of a set of storage cells. The age parameter may be a program/erase cycle count for the set of storage cells, a read count for the set of storage cells, a retention time since a previous write for the set of storage cells, a dwell time for the set of storage cells such as a logical or physical erase block, or the like. Means for determining an age parameter may include a media characteristic module 304, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining an age parameter.

Next, the soft read module 202 sets 704 a number of soft read operations based on the age parameter. For example, storage cells with greater age (e.g., higher program/erase cycle count) may be more susceptible to state drift and more soft read operations may be needed to determine a stored read voltage. Additionally, the soft read module 202 may set 706 soft read thresholds based on the age parameter. For example, storage cells with less age may benefit from narrower soft read voltage threshold spacing than storage cells with greater age. Means for setting the number of soft read operations and/or the soft read thresholds may include a soft read module 202, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for setting the number of soft read operations and/or soft read thresholds.

The soft read module 202 receives 708 soft read data or information from a plurality of soft read operations. The soft read data or information comprises results of the plurality of soft read operations. In some embodiments, the soft read data or information indicates whether certain soft read thresholds are met. In some embodiments, the soft read data or information indicates a microstate in which the storage cell resides. Means for performing the plurality of soft read operations may include a soft read module 202, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for performing the plurality of soft read operations.

After obtaining the soft read data or information, the distribution module 204 and/or the parameter module 206 determine 710 a read voltage threshold or other configuration parameter using the soft read data or information. In some embodiments, the read voltage threshold or other configuration parameter is determined 710 by selecting a soft read threshold based on which soft read thresholds were satisfied. In some embodiments, the read voltage threshold or other configuration parameter is based on the microstate in which the storage cell resides. Means for determining the read voltage threshold or other configuration parameter may include a distribution module 204, a parameter module 206, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining the read voltage threshold or other configuration parameter.

The health module 306 compares 712 the new (e.g., determined 710) read threshold to a health threshold. In some embodiments, the health threshold is indicative of a need to adjust the read voltage threshold or other configuration parameter. If the new read voltage threshold or other configuration parameter satisfies the health threshold, then no further action is performed and the method 700 ends. Means for comparing the new read voltage threshold or other configuration parameter to the target threshold may include a health module 306, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for comparing the new read voltage threshold or other configuration parameter to the target threshold.

If the new read voltage threshold or other configuration parameter does not satisfy the health threshold, then the media configuration module 302 updates 714 a read voltage threshold parameter or other configuration parameter for the non-volatile memory media 122. In some embodiments, the new read voltage threshold or other configuration parameter replaces a default read voltage threshold or other default configuration parameter. In some embodiments, the new read voltage threshold or other configuration parameter replaces a previously modified read voltage threshold or other configuration parameter. Means for updating a read voltage threshold parameter or other configuration parameter may include a media configuration module 302, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for updating a read voltage threshold parameter or other configuration parameter.

In some embodiments, the write threshold module 308 determines 716 a write voltage threshold for the storage cell. The write voltage threshold may be determined 716 based on the read voltage threshold or other configuration parameter or on the soft read data or information. In further embodiments, the write threshold module 308 updates a write voltage threshold parameter for the non-volatile memory media 122 based on the determined write voltage threshold. In some embodiments, the new write voltage threshold replaces a default write voltage threshold. In some embodiments, the new write voltage threshold replaces a previously modified write voltage threshold. The method 700 then ends. Means for determining and/or updating a write voltage threshold may include a write threshold module 308, a configuration parameter module 150, a non-volatile memory controller 124, a non-volatile memory media controller 126, a device driver such as an SML 130, a processor 111, other logic hardware and/or other executable code stored on a computer readable storage medium. Other embodiments may include similar or equivalent means for determining and/or updating a write voltage threshold.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
obtaining soft read data for a storage cell of a non-volatile storage medium;
determining a configuration parameter for the storage cell based on the soft read data; and
using the determined configuration parameter to read data from the storage cell.

2. The method of claim 1, further comprising issuing a soft read command to a non-volatile memory element comprising the non-volatile storage medium, the soft read command issued for an error-correcting code (ECC) decoding operation such that the soft read data is used for the ECC decoding operation and for determining the configuration parameter.

3. The method of claim 1, wherein obtaining the soft read data comprises a non-volatile memory element performing a plurality of soft read operations in response to receiving a soft read command.

4. The method of claim 1, wherein obtaining the soft read data comprises receiving the soft read data from an error-correcting code (ECC) decoder.

5. The method of claim 1, further comprising providing the soft read data to an error-correcting code (ECC) decoder for correcting one or more data errors.

6. The method of claim 1, wherein the configuration parameter is determined without correcting data of the cell using an error-correcting code (ECC) decoding operation.

7. The method of claim 1, wherein the soft read data is obtained in response to one or more of a background scan for the storage cell, a storage capacity recovery event for the storage cell, a read request for data of the cell, and an error-correcting code (ECC) decoding operation for data of the cell.

8. The method of claim 1, wherein determining the soft read data comprises:
performing a first soft read operation using a first set of configuration parameters; and
performing a second soft read operation using a second set of configuration parameters, the second set of configuration parameters differing from the first set of configuration parameters, the soft read data comprising results from the first and second read operations.

9. The method of claim 1, further comprising determining whether the configuration parameter has been moved beyond a health threshold.

10. The method of claim 9, further comprising, in response to determining that the configuration parameter has been moved beyond a health threshold:
preserving valid data from an erase block comprising the storage cell in a different erase block in response to reading the valid data using the determined configuration parameter; and
performing a storage capacity recovery operation for the erase block in response to preserving the valid data.

11. The method of claim 9, further comprising performing one or more of: a retirement operation, a storage capacity recovery operation, and a conversion from a multi-level cell mode to a single-level cell mode for the storage cell, in response to determining that the configuration parameter has been moved beyond the health threshold.

12. The method of claim 1, further comprising determining a distribution model of stored read voltage levels for a set of storage cells comprising the storage cell based on soft read data for the set of storage cells, the configuration parameter for the storage cell determined based on the distribution model.

13. The method of claim 1, further comprising determining a write voltage threshold for the storage cell based on one of the soft read data and the determined configuration parameter, the determined configuration parameter comprising a read voltage threshold.

14. An apparatus comprising:
a soft read module configured to issue a soft read command for a set of cells of a non-volatile memory medium;
a parameter module configured to adjust a read voltage threshold for the set of cells based on soft read information received in response to the soft read command; and
an error-correcting code (ECC) decoder configured to correct one or more errors in data of the set of storage cells using the soft read information.

15. The apparatus of claim 14, wherein the soft read module is configured to one or more of receive the soft read information from the error-correcting code decoder and provide the soft read information to the error-correcting code decoder.

16. The apparatus of claim 14, further comprising a media configuration module configured to configure the non-volatile memory medium to use the adjusted read voltage thresholds for the set of cells.

17. The apparatus of claim 14, wherein the soft read module is configured to issue three or more soft read commands for the set of cells, each soft read command triggering three or more soft reads of the set of cells.

18. An apparatus comprising:
means for obtaining soft sensing information for storage cells of a non-volatile recording medium in response to a read request;
means for determining a read voltage threshold for the storage cells, the read voltage threshold determined based on the soft sensing information; and
means for reading data from the storage cells using the determined read voltage threshold.

19. The apparatus of claim 18, further comprising:
means for one or more of receiving the soft sensing information from an error-correcting code decoder and providing the soft sensing information to an error-correcting code decoder.

20. The apparatus of claim 18, further comprising means for correcting one or more errors in the data using the soft sensing information.
